(19) United States
(12) Patent Application Publication
(10) Pub. No.: US 2026/0163341 A1
(43) Pub. Date: Jun. 11, 2026

(54) SYSTEM AND METHODS FOR CABLE STRINGING USING AERIAL VEHICLES

(71) Applicant: Sherman + Reilly, Inc., Chattanooga, TN (US)

(72) Inventors: Toni Corinne Tran, Chattanooga, TN (US); Douglas Bruce MacDonald, Dawsonville, GA (US); Isaac Piche, Coarsegold, CA (US)

(21) Appl. No.: 19/408,793

(22) Filed: Dec. 4, 2025

Related U.S. Application Data
(60) Provisional application No. 63/728,341, filed on Dec. 5, 2024.

(51) Int. Cl. H02G 1/04; B64U 10/13; B64U 101/25

(52) U.S. Cl. CPC H02G 1/04; B64U 10/13; B64U 2101/25

(57) ABSTRACT

The disclosed technology relates generally to a stringing block that includes an arm and gate configured to allow an upward ingress during a cable stringing process. The process of upwards ingress can include a first end of a cable being moved from a first side of the stringing block to a second side of the stringing block using an aerial vehicle, such that at least a portion of the cable is positioned underneath the arm. The arm of the stringing block can extend downwardly from the frame at an oblique angle, such that during upward ingress the cable can contact a bottom surface of the arm. The cable can further slide upward along the arm and pass through the gate into a port of the stringing block, such that the port may transfer the cable to a sheave and temporarily store the cable.

### CROSS-REFERENCE TO RELATED APPLICATIONS

This application claims the benefit, under 35 U.S.C. § 119(e), of United States Provisional Patent Application No. 63/728,341, filed December 5, 2024, the entire contents and substance of which are incorporated herein by reference in their entirety as if fully set forth below.

### FIELD OF TECHNOLOGY

The disclosed technology relates generally to methods and systems of stringing utility lines and other suspended cable systems, and, more particularly, using an aerial vehicle and one or more stringing blocks to install utility lines or other suspended cable systems on support structures.

### BACKGROUND

High voltage utility transmission lines can transmit power over hundreds of miles with minimal losses because of the very high voltages used. Step-up transformers located at utility power generation plants increase the voltage transmission levels which minimizes losses due to the resistance of the transmission line (i.e., the conductor). As electrical demand continues to grow, higher-capacity lines and/or additional lines are needed.

Typically, high voltage utility transmission lines are installed by stringing the utility lines over great distances using equipment specifically designed to pull and tension the utility line. Other utility lines (conductors, fiber optic cables, and the like) can be installed using the same or similar methods and equipment. A utility line installation process according to known methods can include installing stringing blocks on each support structure (power poles, suspension towers, etc.), stringing a pilot line or pulling line through each stringing block, pulling the utility line through the stringing blocks, bringing the utility line to a proper tension, and then clipping the utility line in place on the support structure.

Before the utility line is pulled into place, the pulling line can be threaded through each of the stringing blocks to be installed. Sometimes a pilot line, which is a smaller, lighter line, can be first threaded through the stringing blocks and used to pull the pulling line into place. Other times, the pulling line can be threaded directly through the stringing blocks without the need to use a pilot line (for the sake of simplicity, the pilot line and the pulling line are referred to collectively herein as a “cable”). In either case, the cable is installed either manually through each stringing block or a helicopter or unmanned aerial vehicle (UAV) is used to thread the cable through each stringing block. As will be appreciated, manually threading the cable through the stringing blocks can be laborious, time-consuming, and dangerous. For example, current manual stringing methods can span between 5 and 7 hours in some situations, under standard conditions. Although often faster than manually threading the cable, using a helicopter to install the cable is expensive and dangerous. Helicopter-based methods can incur costs of approximately $2,000-$5,000 per hour, along with high risk from low-altitude operation. Furthermore, although UAVs can also be used to thread the cable through the stringing blocks, but the current processes and devices are typically inefficient. For example, in traditional methods, aerial vehicles are required to fly past the stringing block and lower the cable into a gate of the stringing block, which can be difficult and is often unsuccessful. Additionally, it is difficult to execute line ingress using traditional drone stringing methods, especially at significantly far visual distances. Considering this and the danger from energized power lines and external conditions, such as high winds, current stringing blocks require a significant amount of time and effort to properly string utility lines through them.

What is needed, therefore, is a method and system that significantly reduces the time and effort for stringing utility lines. These and other advantages of the presently disclosed technology will become apparent throughout the following disclosure.

### SUMMARY

The disclosed technology relates generally to systems and methods of stringing utility lines. Unlike existing methods which use a downwards ingress to install the utility line into a stringing block, the disclosed technology uses an upwards ingress, guiding the cable upwards into an arm of the stringing block. Rather than moving the utility line over the arm of a stringing block, the disclosed technology can move the utility line under the arm of the stringing block, followed by an upwards movement of the cable such that the cable contacts a bottom surface of the arm and slides upwardly along the arm until the cable passed through a gate and properly installed on the stringing block. In this way, the upwards ingress method can be adaptable for various line-stringing tasks, including lightweight pilot lines, fiber optic cables, full scale utility lines, and similar tasks. The upwards ingress method and devices described herein enables a more efficient installation of the utility lines in that it can be completed faster and is less susceptible to disruption via external factors, such as high winds. As a result, the upwards ingress method and devices can enable integration with aerial vehicles of varying payload capacities, which may include autonomous systems. During downwards ingress, the gravity can cause the cable to have more slack which makes the stringing process difficult. The disclosed technology, rather, works against gravity, which can naturally tension the cable when the cable comes into contact with the arm, resulting in a smoother transition into the stringing block. In this way, the disclosed technology achieves a more efficient method of stringing utility lines as compared to existing systems and methods. As a result, the disclosed technology can dramatically reduce installation times for utility lines, in some instances reducing installation time by 40% or more.

The disclosed technology can employ a method of stringing utility lines that includes the upward ingress as described herein. The method can be initiated by moving a first end of a cable from a first side of a stringing block to a second side of the stringing block, such that the cable extends past the stringing block. To achieve upwards ingress, the method can further include moving the cable upwards until the cable contacts a bottom surface of an arm extending outwardly from the stringing block. Completing the process of stringing the utility line, the method can further include causing the cable to pass through a gate of the stringing block and into a port of the stringing block by moving the cable upwards along the arm until the cable passes through the gate.

To achieve the above-described method of upwards ingress for stringing a cable, a novel stringing block is employed. The stringing block may include a sheave and a frame. The sheave, as is understood in the art, can be configured to receive a cable as part of the stringing process. The frame can include a port configured to receive the cable; and a gate. The stringing block, as will be described in greater detail herein, can include an arm extending downwardly from the frame at an oblique angle. That is, when the cable comes into contact with a bottom surface of the arm, the arm may extend in such a fashion that during upwards ingress, the cable may slide towards a gate of the stringing block. The gate of the stringing block, as will be described in greater detail herein, can be configured to permit entry of the cable into the port. The port of the stringing block can be configured to transfer the cable to the sheave, such that the cable may be temporarily stored by the stringing block. In this way, the stringing block of the present disclosure is configured to facilitate the methods of upwards ingress for stringing utility lines as described herein.

### BRIEF DESCRIPTION OF THE DRAWINGS

The accompanying drawings, which are incorporated in and constitute a part of this specification, illustrate various aspects of the presently disclosed subject matter and serve to explain the principles of the presently disclosed subject matter. The drawings are not intended to limit the scope of the presently disclosed subject matter in any manner.

FIG. 1 illustrates an isometric view of a stringing block, in accordance with examples of the present disclosure.

FIG. 2 illustrates a front view of a stringing block, in accordance with examples of the present disclosure.

FIG. 3A illustrates an isometric view of a gate in a closed configuration, in accordance with examples of the present disclosure.

FIG. 3B illustrates an isometric view of a gate in an open configuration, in accordance with examples of the present disclosure.

FIG. 3C illustrates a front view of a stringing block including a gate in an open configuration, in accordance with examples of the present disclosure.

FIG. 4 illustrates a front view of a stringing block including a hook, in accordance with examples of the present disclosure.

FIG. 5 illustrates a front view of a stringing block including one or more ridges, in accordance with examples of the present disclosure.

FIGS. 6A, 6B, and 6C illustrate a side view of a progression of an aerial vehicle stringing cable into a stringing block, in accordance with examples of the present disclosure.

FIG. 7 illustrates an example of using an aerial vehicle and a plurality of stringing blocks to string utility lines, in accordance with examples of the present disclosure.

FIG. 8 illustrates a front view of a stringing block including multiple arms, in accordance with examples of the present disclosure.

FIG. 9 illustrates a front view of a stringing block including multiple arms, in accordance with examples of the present disclosure.

FIG. 10A illustrates a side view of a stringing block including multiple arms, in accordance with examples of the present disclosure.

FIG. 10B illustrates a side view of a stringing block including a plate, in accordance with examples of the present disclosure.

FIG. 11A illustrates an isometric view of a stringing block including multiple arms, in accordance with examples of the present disclosure.

FIG. 11B illustrates an isometric view of a stringing block including multiple arms, in accordance with examples of the present disclosure.

FIG. 12 illustrates an isometric view of a stringing block including multiple arms in a closed configuration, in accordance with examples of the present disclosure.

FIG. 13 illustrates an isometric view of a stringing block including a hook, in accordance with examples of the present disclosure.

FIG. 14 illustrates an isometric view of a stringing block including a plurality of ridges, in accordance with examples of the present disclosure.

FIG. 15 illustrates an isometric view of a stringing block including a plurality of flexible members, in accordance with examples of the present disclosure.

FIG. 16 is a flow chart of a method of stringing utility lines, in accordance with examples of the present disclosure.

### DETAILED DESCRIPTION

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of systems and methods of stringing utility lines used for power transmission using an aerial vehicle and stringing assemblies. The present disclosure, however, is not so limited, and can be applicable in other contexts such as systems and methods used for stringing other energy transmission or communication lines, ski lifts, material conveyance systems, zip lines, etc. Accordingly, when the present disclosure is described in the context of systems and methods of stringing utility lines used for power transmission using an aerial vehicle and stringing assemblies, it will be understood that other implementations can take the place of those referred to herein.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

As used herein, the term “cable” can be used to describe a rope, a cord, a cable, a line, a bull line, a string, a strand, or other similar components that can be used in a stringing process. Thus, the term “cable” should not be construed narrowly. Furthermore, in some instances, the term “cable” can be used to describe a pilot line or a pulling line, depending on the particular context.

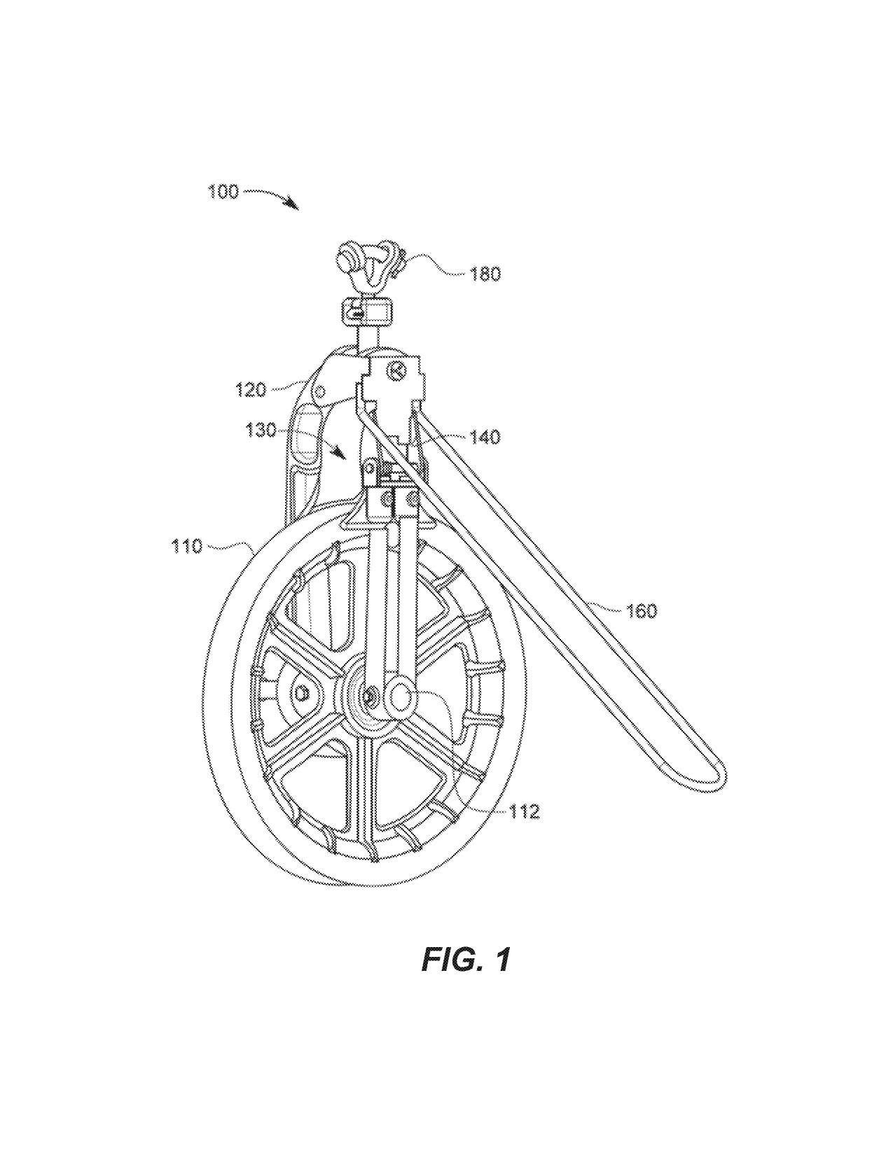

Referring now to the drawings, in which like numerals represent like elements, the present disclosure is herein described. FIG. 1 illustrates an example stringing block 100 according to the disclosed technology. Similar to existing systems, the disclosed technology can receive a cable via a pilot line or pulling line directed by an aerial vehicle (e.g., a helicopter or an unmanned aerial vehicle (UAV)). Unlike existing systems, however, the disclosed technology includes an arm that is complimentary with an upward ingress of the cable when moved upwardly by the aerial vehicle while stringing the cable.

The stringing block 100, as shown in FIG. 1, can include a sheave 110 attached to a frame 120. The sheave 110 can be a pulley, wheel, or other similar terms used in the art. The sheave 110 can be configured to rotate about an axle 112 that is attached to the frame 120. The sheave 110 can be configured to support the cable during the process of stringing utility lines on a support structure. As will be appreciated, the sheave 110 may rotate and advance the cable as the aerial vehicle advances to the next stringing block 100 during the process of stringing utility lines. The sheave 110, in some embodiments, can include a plurality of grooves configured to each support one or more cables. According to another embodiment, the sheave 110 can be one of a plurality of sheaves within a single stringing block, where each of the plurality of sheaves is configured to support one or more cables.

The frame 120, in some embodiments, can include a port 130. The port 130 can be configured to temporarily store the cable during the process of stringing utility lines. For example, the port 130 can be a part of the frame 120 surrounding the sheave 110, such that the port 130 can be an opening configured to receive one or more cables. In some embodiments, the port 130 may include an aperture such that cable may advance through the aperture as the aerial vehicle advances the cable while stringing the cable.

The frame 120 can further include a gate 140 that can be pushed open by pulling the cable up against the gate 140. As will be described in greater detail herein, when the gate 140 is opened, the cable can be moved into the port 130 and aligned on the sheave 110. The gate 140, in other words, can be configured to permit entry of one or more cables into the port 130 so that the cable can rest on the sheave 110.

The stringing block 100 can further include an arm 160. As will be described in greater detail herein, the arm 160 can be configured to guide the cable toward the gate 140 during an upward movement of the aerial vehicle while the aerial vehicle is moving the cable. The arm 160 extends downwardly from the frame at an oblique angle to help guide the cable along the arm 160 toward the gate 140. The arm 160 can include one or more rods attached to the frame 120. For example, the one or more rods can be a plurality of rods and, in some embodiments, each rod of the plurality of rods can extend substantially parallel to one another to form the arm 160. The plurality of rods can connect to one another and to the frame 120. In an example embodiment, each rod can be made up of a metal material, such that the rods can withstand substantial forces at a distal end of each rod. In some embodiments, the arm 160, the rod, or any embodiments of arms or rods discussed herein, can include a non-conductive material, for example plastic or fiberglass. Further, the arm 160, rods, or any embodiments of arms retroreflective or dayglow components, such that the arm 160, or any embodiments of arms discussed herein, can be visible from a distance. Additionally, the arm 160, or any embodiments of arms discussed herein, can include lighting so as to enhance visibility of the arm. The lighting, in some embodiments, can be solar or battery powered

The stringing block can further include a top connection 180. The top connection 180 can be the attachment point of the stringing block 100 to a support structure. In some embodiments, the stringing block 100 can hang from the support structure via an attachment of the top connection 180 to an element of the support structure (e.g., crossarms of the support structure). The top connection 180, as will be appreciated, can be located at a top end of the stringing block 100, and can be configured to be attached to the support structure. However, the stringing block 100 should not be limited to attaching to a support structure via the top end. The stringing block 100 may include attachment points on any point of the frame 120 depending on the support structure from which the stringing block 100 is attached.

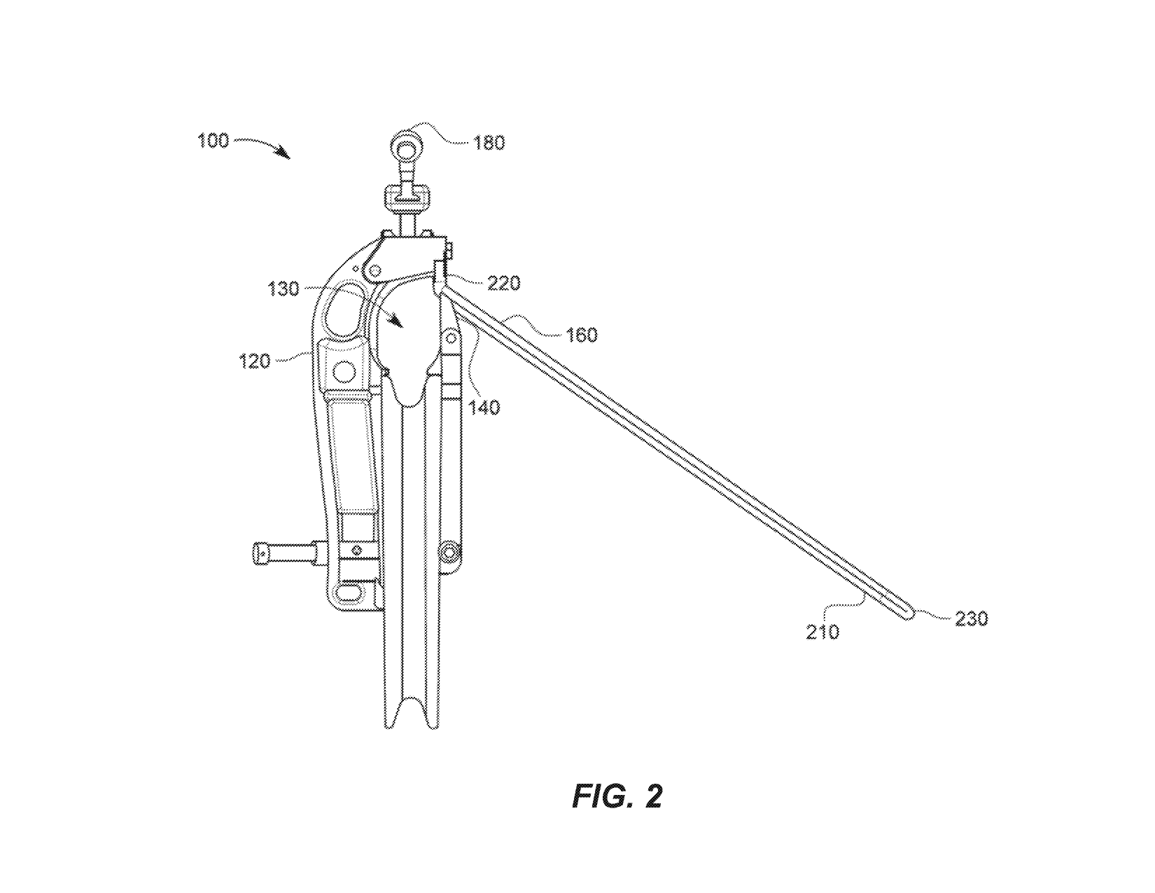

FIG. 2 illustrates a side view of the stringing block 100 according to the disclosed technology. As shown in FIG. 2, the arm 160 can further include a proximal end 220 and a distal end 230. The proximal end 220 can be a point of attachment of the arm 160 to the frame 120. In some embodiments, the arm 160 is angled with reference to the frame 120 such that the arm 160 can extend outwards and downwards from the frame 120 at an oblique angle, or away from the top end. As shown in FIG. 2, the arm 160 can extend at an angle with reference to the frame 120 at least in the plane as evident in the side view presented in FIG. 2. The angle of the arm 160 with reference to the frame 120 can be optimized to create a mechanical advantage, thereby improving the efficiency of the stringing process. For example, the arm 160 can be at an angle of approximately 45 degrees downward with reference to the frame 120. In some embodiments, the angle of the arm 160 can be adjustable. That is, the arm 160 can further include an adjustable mechanism, such as a hinge located at the proximal end 220, such that the angle from which the arm 160 extends outwards and downwards may be manually or automatically adjusted.

During the stringing process, where the cable is received by the port 130, the cable can be navigated such that when at least a portion of the cable is positioned below the arm 160 and the aerial vehicle moves upwards, the cable can contact and then travel along the arm 160 from the distal end 230 to the proximal end 220. In some embodiments, the cable can come into contact with a bottom surface 210 of the arm 160 during upward ingress. As will be described in greater detail herein, the cable can be received into the port 130 via the gate 140 after travelling generally from the distal end 230 to the proximal end 220, or proximally, along the arm 160 during upward ingress. A method of stringing cable using an upward ingress of the aerial vehicle will be described in greater detail herein.

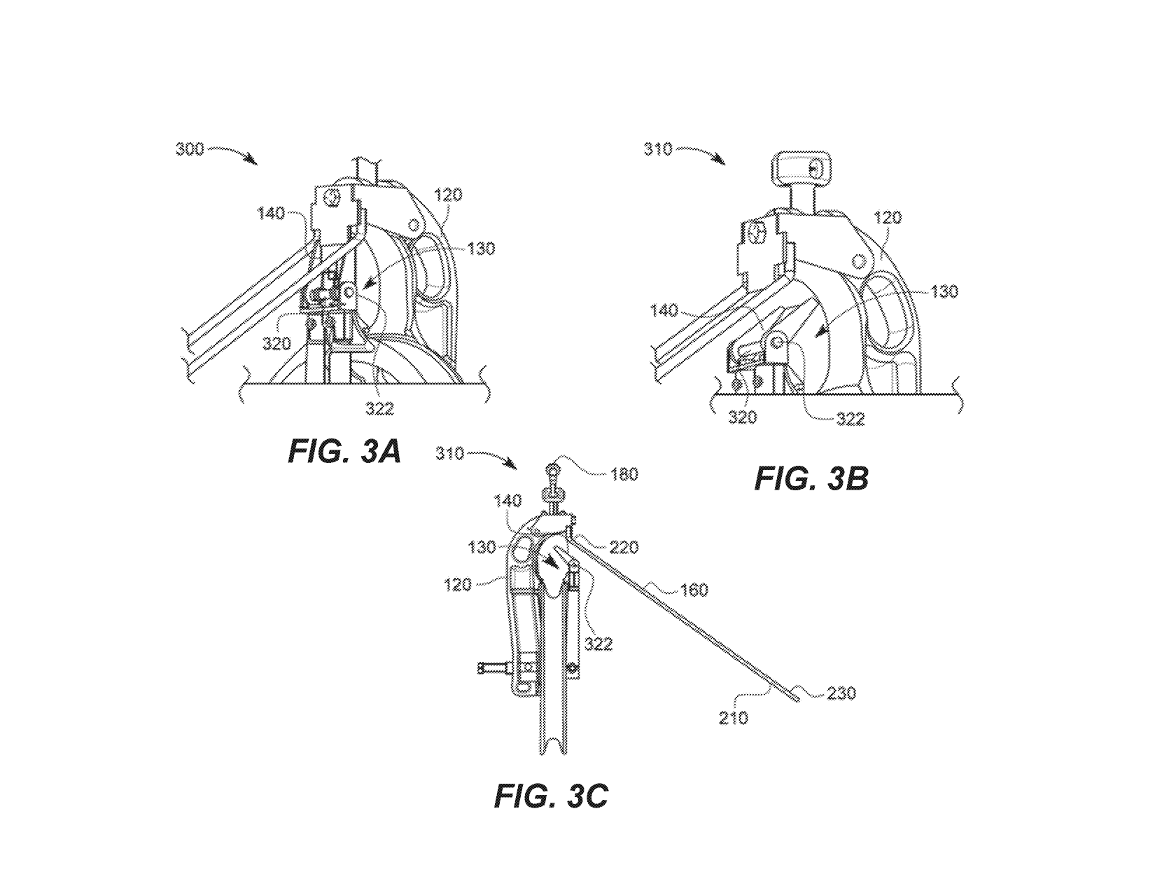

FIGS. 3A and 3B illustrate a close up perspective view of a closed configuration 300 and open configuration 310, respectively, of the gate 140 according to the disclosed invention. As shown in FIG. 3A, the gate 140 can have a normally closed configuration 300, such that entry or exit into the port is at least temporarily blocked. The closed configuration 300 of the gate 140 can be such that if the port 130 contains any cables of the cable, the cable is at least temporarily secure. During upward ingress, or as the cable is navigated toward the proximal end 220 of the arm 160, the cable can come into contact with the gate 140. As will be described in greater detail herein, the cable may be pulled against the gate 140 to open the gate 140. The cable, in some embodiments, can open the gate 140 during upward ingress due at least in part to the mechanical advantage created by the arm 160 and the pulling by the aerial vehicle. The cable may exert a force on the gate 140, in some embodiments, which can transition the gate 140, at least temporarily, to the open configuration 310. In some embodiments, the method of stringing utility lines may include causing the cable to pass through the gate 140 of the stringing block 100 and into the port 130 of the stringing block 100 by moving the cable upwards along the arm 160 until the cable passes through the gate 140. That is, the cable may be caused to open the gate 140, or transition the gate 140 from a closed configuration 300 to an open configuration 310, such that the cable may enter the port 130.

The open configuration 310 of the gate 140 is illustrated in FIGS. 3B and 3C. As shown in FIG. 3B, the gate 140 can be configured to prevent the cable to exit the port 130 without assistance by a lineman or the like. Similarly, the gate 140 can be configured to permit a one way entry into the port 130. The gate 140, in some examples, can include a spring 320 and a hinge 322. The spring 320 and the hinge 322 can be configured to transition the gate 140 from the open configuration 310 to the closed configuration 300. For example, the spring 320 can be a torsional spring, or similar mechanisms known in the art, and can be used to automatically transition the gate 140 from the open configuration 310 back to the closed configuration 300, in some embodiments occurring after the cable has been received into the port 130. In this way, the gate 140 can be configured to be normally-closed until a sufficient force (e.g., the cable) is applied to it. In some embodiments, the gate 140 can include a magnetic component, such that the magnetic component can be configured to automatically close the gate 140. The gate 140, in some embodiments, can further include an electronic component, such that the gate 140 can be configured to automatically open and close based at least in part on an actuation of the electronic component. The gate 140 can be configured to open into an aperture of the port 130, such that the cable may be received into the port 130 via the gate 140. In some embodiments, the gate 140 can be a single rounded bar, which may be characterized by having a smooth surface, such that the smooth surface can be configured to prevent the cable from becoming caught on or tangled with the gate 140 during ingress.

FIG. 3C illustrates a side view of the open configuration 310 of the gate 140. As shown in FIG. 3C, the gate 140 can open into the port 130 such that a path is created for the cable to pass into the port 130. That is, the hinge 322 can be configured to allow the gate 140 to open into the port 130. As will be appreciated, if the cable slides from the proximal end 230 to the distal end 220 along the arm 160, the hinge 322 can be configured such that when the cable applies a force to the gate 140, the gate 140 can open in a direction into the port 130 to allow the cable to pass into the port 130.

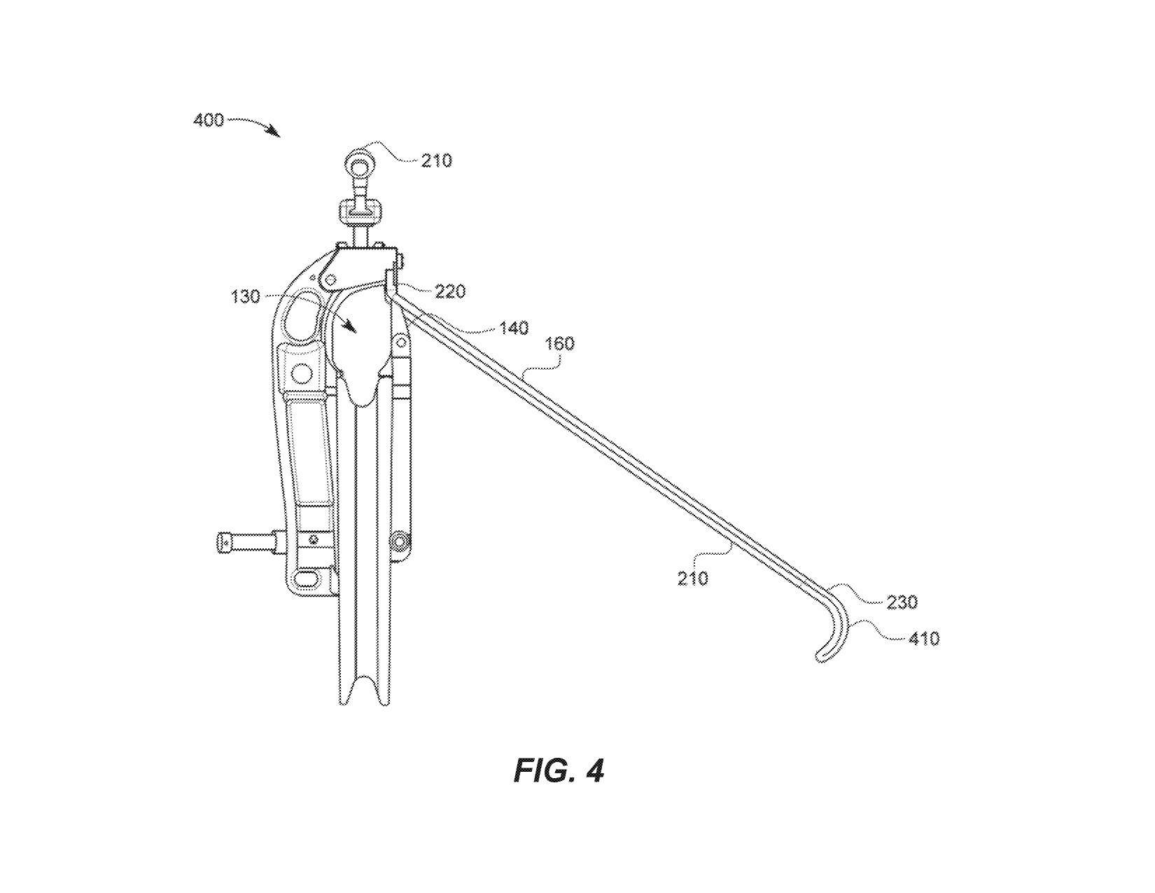

FIG. 4 illustrates an example stringing block 400 including a hook 410. The hook 410 can be located at the distal end 230 of the arm 160. The hook 410 can help prevent the cable from sliding away and off the arm 160 during upward ingress. During the stringing process, external factors, such as high winds, can cause the cable to move erratically, and in some cases, slide off of the arm 160 during upward ingress. To prevent this phenomenon and to improve efficiency of the method of stringing in accordance with the disclosed technology, the hook 410 can help to ensure the cable does not slide off of the arm 160. Further, a plurality of hooks can also be placed anywhere along the length of the arm between the proximal end 220 and the distal end 230. In some embodiments, each hook of the plurality of hooks can be smaller than the hook located at the distal end 230. For example, if an external factor, such as high winds, were to occur during upward ingress, the cable could be temporarily secured via one of the plurality of hooks. The plurality of hooks can be configured to prevent sliding of the cable toward the distal end 230 of the arm 160 during upward ingress.

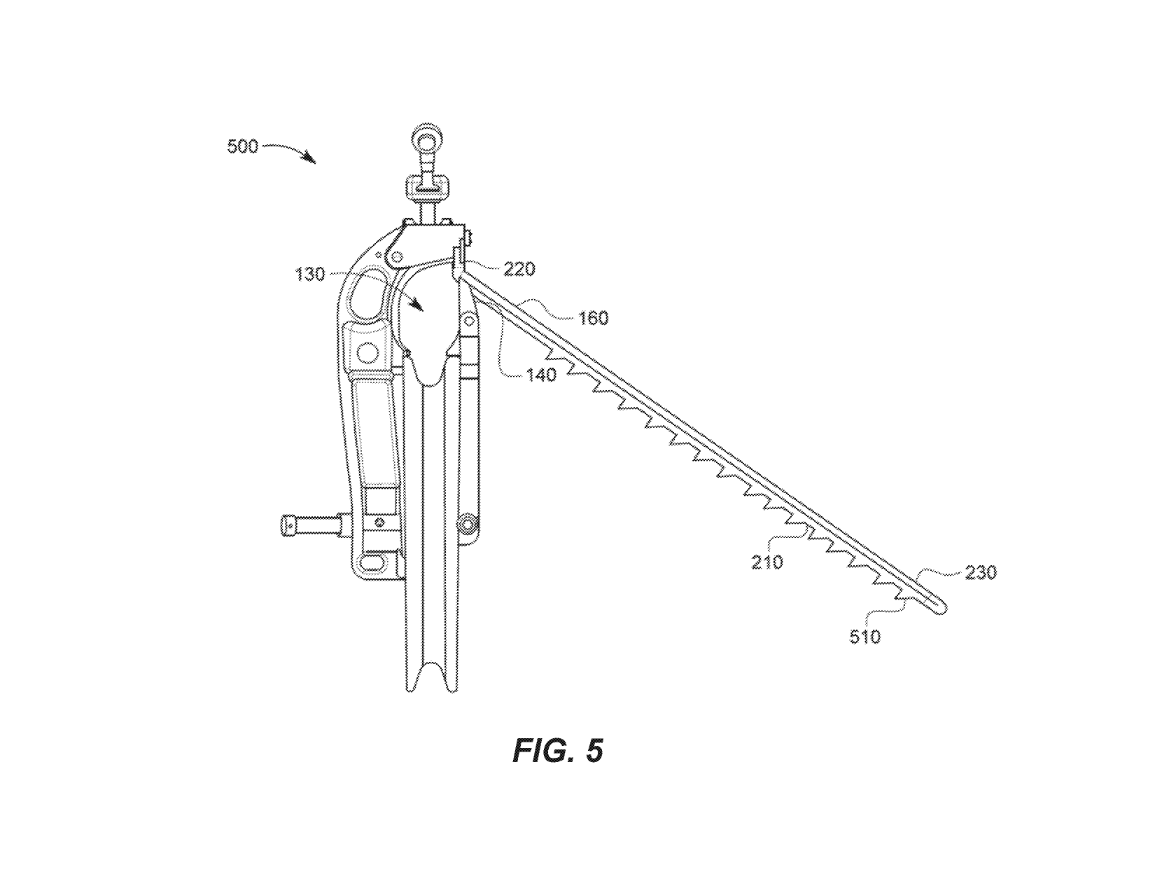

FIG. 5 illustrates an example stringing block 500 including one or more ridges 510. As shown in FIG. 5, the one or more ridges 510 can be a plurality of ridges positioned along the bottom surface 210 of the arm 160. In some embodiments, the one or more ridges 510 can span the length of the arm 160. In the case of multiple ridges, the ridges may vary in size and shape. In an example embodiment, the ridges may increase or decrease in size from the distal end 230 to the proximal end 220. The one or more ridges 510 can be configured to serve a similar purpose to the hook 410, such that the one or more ridges 510 can be configured to prevent the cable from sliding distally along the arm 160. That is, the one or more ridges 510 may prevent one or more cables from sliding from the proximal end 220 toward the distal end 230 of the arm during upward ingress. In a situation in which external factors, such as high winds, are causing unpredictable motion of the cable, the one or more ridges 510 may help to temporarily hold the cable in place until the external factors subside. In some embodiments, the one or more ridges 510 can include a plurality of flexible components arranged to permit the cable to pass along the arm 160 toward the gate 140, but not backwards away from the gate 140. For example, the one or more ridges 510 can be polymeric pieces that are arranged to bend toward the gate when the cable is moved along the arm 160 toward the gate 140, but be configured to bend backwards if the cable is moved away from the gate 140, thereby preventing the cable from moving away from the gate 140. Alternatively, the one or more ridges 510 can be spring loaded, similar to embodiments of the gate 140, such that the one or more ridges 510 can be characterized to rotate to allow the cable to slide proximally along the length of the arm 160, while also being configured to prevent the cable from sliding distally along the length of the arm 160 via the spring loading.

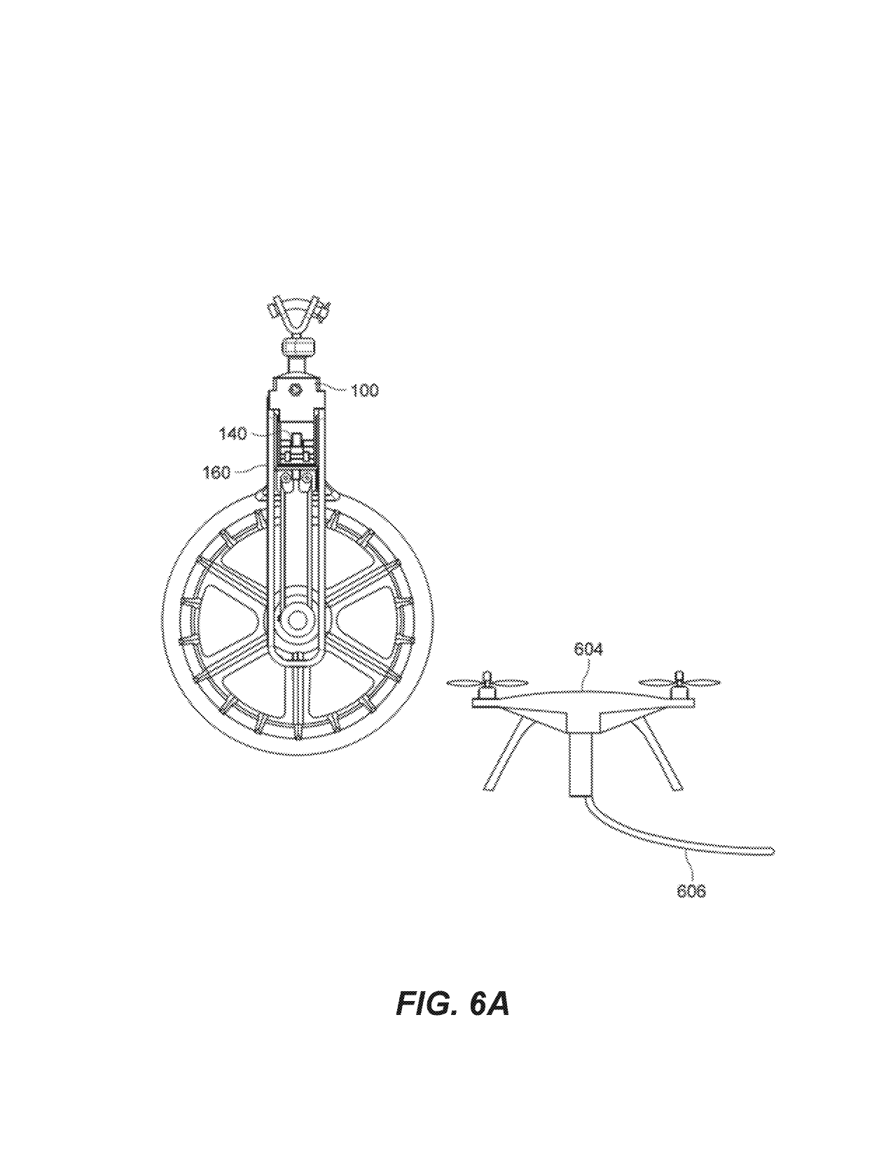

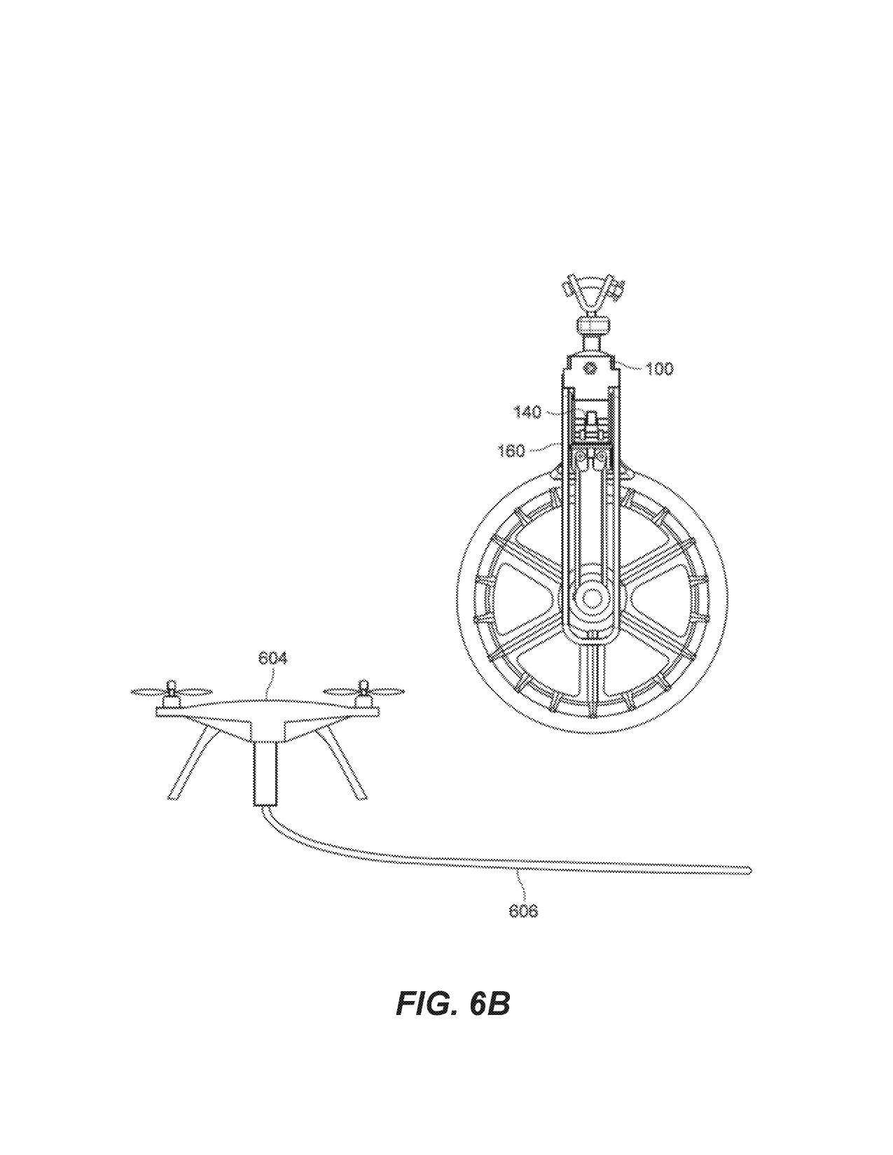

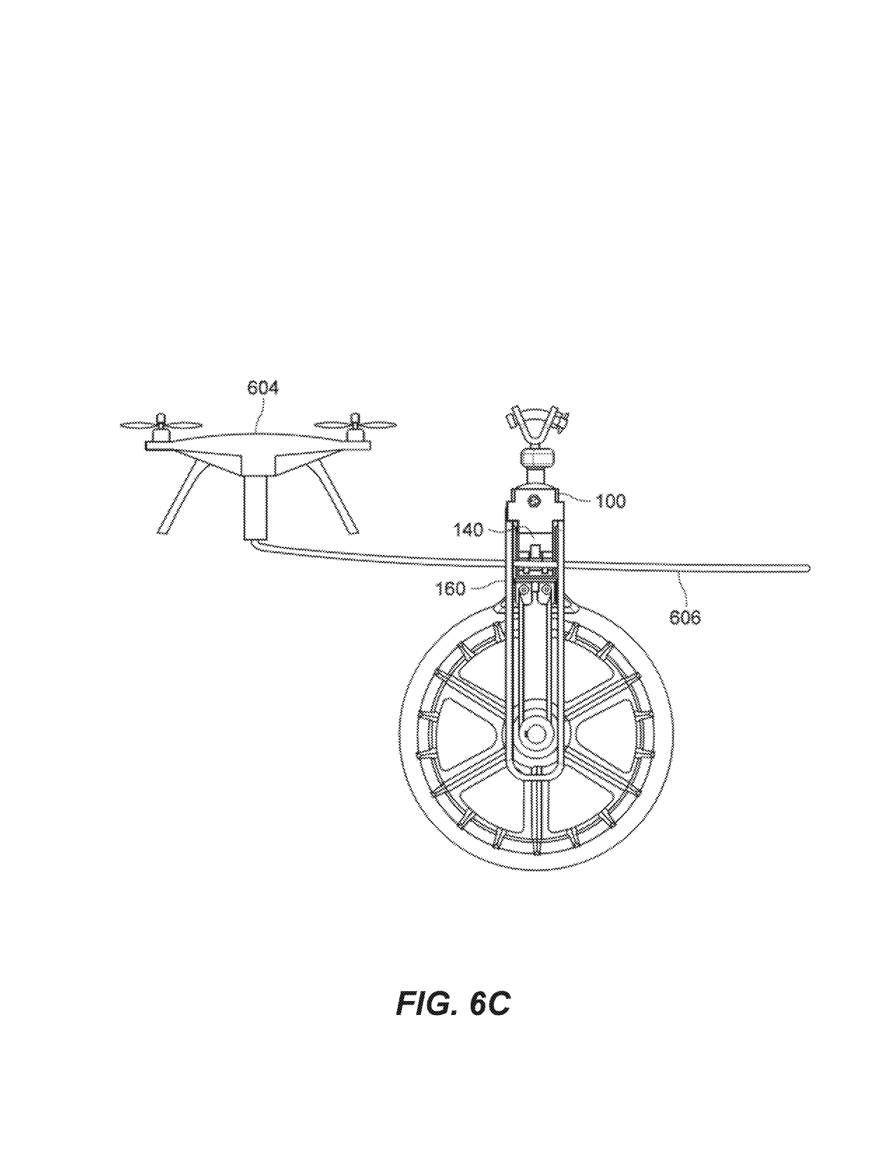

FIGS. 6A-C illustrate an example progression of a method of stringing utility lines according to the disclosed invention. As shown in FIG. 6A, the progression can be initiated by an aerial vehicle 604 approaching a stringing block 100 pulling a cable 606. In some embodiments, the aerial vehicle 604 approaches a first side of the stringing block 100. The aerial vehicle 604 can have a cable 602 in tow, or more specifically the cable 602 can include a first end attached to the aerial vehicle 604 while the aerial vehicle 604 is moving. For the purposes of fully describing the method, the stringing block 100 can be any embodiment of stringing blocks as described herein, including but not limited to: the stringing block 100, the stringing block 400, and the stringing block 500. Further, the cable 606 can include one or more cables, multiple cables, a plurality of cables, or a pilot line/pulling cables. The aerial vehicle, as is described in greater detail herein, can be an unmanned aerial vehicle (UAV) as illustrated in FIGS. 6A-C, or the aerial vehicle can be a helicopter depending on the particular situation.

As shown in FIG. 6B, the aerial vehicle 604 can navigate past the stringing block 100. In some embodiments, the aerial vehicle 604 can navigate from the first end of the stringing block 100 to a second end of the stringing block 100. Further, the aerial vehicle 604 can pass underneath the arm 160 or navigate the cable 606 such that at least a portion of the cable 606can be positioned underneath the arm 160. The positioning underneath the arm 160 is such that if the cable 606 is navigated upwards, for example, during an upward ingress maneuver, the cable 606 will contact the bottom surface 210 of the arm 160.

As shown in FIG. 6C, the aerial vehicle 604 can navigate upwards, causing the cable 606 to slide along the arm 160, pass through the gate 140, and to be received into the port 130. When the aerial vehicle 604 moves upwards, in some embodiments, at least a portion of the cable 606 can contact the bottom surface 210 of the arm 160. As the aerial vehicle 604 is navigated further upwards, or during an upwards ingress maneuver, the arm 160 can be configured to guide the cable 606 from the distal end 230 of the arm 160 to the proximal end 220 of the arm 160, or towards the gate 140. The cable 606, at a point during the upwards ingress maneuver, can contact the gate 140, and apply a force to the gate 140. The force applied by the cable 606 can be due at least in part to the upwards ingress maneuver navigated by the aerial vehicle 604. As the cable 606 exerts the force on the gate 140, the gate 140 can be configured to open, at least temporarily. The temporary opening of the gate 140 can also be described as a transition from the closed configuration 300 to the open configuration 310 as described herein. Similarly, the gate 140 can be configured to transition from the open configuration 310 to the closed configuration 300 after the cable 606 has been received by the port. Specifically, once the cable 606 is received by the port 130, the cable 606 no longer exerts a force on the gate 140, and thus the gate 140 may automatically close, or be configured to transition from the open configuration to the closed configuration (e.g. by the spring 320) . As described herein, the method can further include causing the cable 606 to pass through the gate 140 of the stringing block 100 and into the port 130 of the stringing block 100. This process may include moving the cable 606 to the gate 140; applying a force on the gate 140 with the cable 606; and passing the cable 606 through the gate 140 when the gate 140 opens due to the force. As can be appreciated, the force applied by the cable 606 on the gate 140 may be due to navigating the aerial vehicle 604 upwards, causing a reactionary force via the arm 160 which directs the cable 606 towards the gate 140. In some embodiments, the aerial vehicle 604 can navigate in such a direction causing the cable 606 to travel towards the gate 140, wherein the direction may be upward or at least partially laterally.

The process of stringing utility lines as described herein can be completed similarly through the use of a pilot line. The cable 606, for example, may include a pilot line, as described herein. The pilot line may include a first end, similar to that which is described for the cable, such that the first end of the pilot line is attached to the aerial vehicle 604 and a second end of the pilot line is attached to one or more trailing cables. As will be appreciated, the one or more trailing cables may be any cable or utility line as described herein. In the process of stringing the utility line, or during upward ingress, the pilot line may come into contact with the bottom surface 210 of the arm 160. The pilot line may similarly move proximally along the length of the arm 160 toward the gate 140 when pulled upwardly by the aerial vehicle 604. The pilot line can further cause the gate 140 to open due to a force applied via the pilot line on the gate 140, ultimately passing the pilot line into the port 130. After being received into the port 130 via the gate 140, the pilot line can be advanced through the port 130, such that the one or more trailing cables are received into the port 130. That is, the second end of the pilot line can be advanced through the port 130 such that the one or more trailing cables are received into the port 130.

The cable 606 may include a high visibility material. As will be appreciated, the high visibility material may be sleeved onto the cable so as to assist the user in navigation of the aerial vehicle 604. In some embodiments, the high visibility material can include retroreflective material interwoven into the cable 606 or a high visibility jacket. The high visibility material can be characterized as being a color which is visible up to around 100 feet away. The high visibility material may also be sleeved on the cable 606 in high wear sections of the cable 606. Additionally, the cable 606 may further include colored sections. The colored sections may be distributed at a uniform distance along the length of the cable 606, such that the user navigating the aerial vehicle 604 may have a better understanding of movement of the cable 606. The colored sections may change in color along the length of the cable 606 so as to indicate a longitudinal position along the length of the cable 606 to the user.

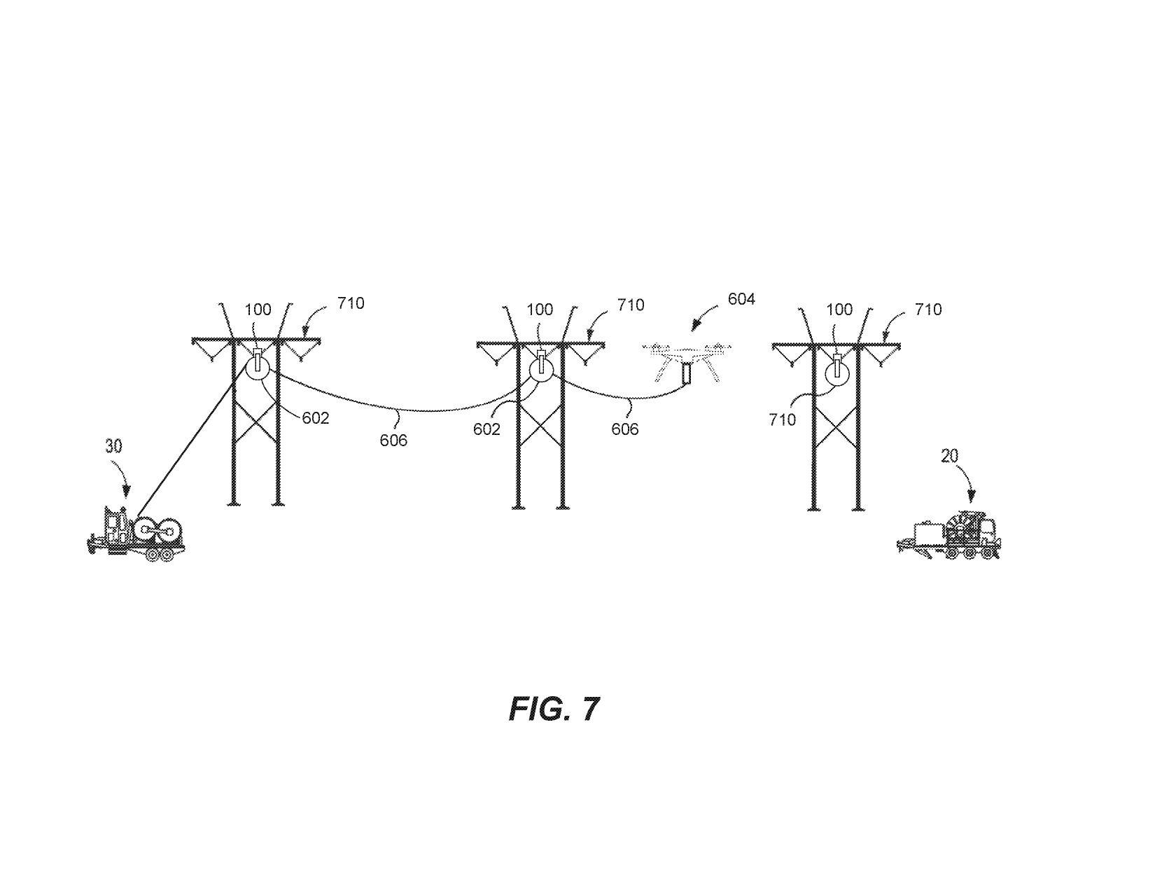

FIG. 7 illustrates an aerial vehicle 604 stringing the cable 606 through a plurality of stringing blocks attached to a plurality of support structure according to the disclosed invention. The plurality of utility towers can include multiple support structures 710. Each support structure 710 can include a stringing block 100. In some embodiments, a support structure 710 can include one or more stringing blocks. The one or more stringing blocks can include multiple of the stringing block 100, as shown. In some embodiments, each stringing block 100 of the one or more stringing blocks can include one or more sheaves for simultaneously temporarily securing the cable 606. For example, the aerial vehicle 604 can sequentially complete the stringing method as described herein on each of the one or more stringing blocks 100.

Similar to existing systems, the disclosed technology can include installing stringing blocks 602 on each support structure 710 (power poles, suspension towers, etc.) and using a puller 20 and a tensioner 30 positioned at either end of the section of utility line to be installed on the support structures 50 to pull a cable 606 into place. The disclosed technology includes an unmanned aerial vehicle (UAV) or a helicopter that is configured to move the cable 606 between each of the stringing blocks 100. In some embodiments, the cable 606 can further include a lead line. The lead line can be attached to one of the cable 606 and the pilot line at the first end of the cable 606, and can be configured to be attached to the aerial vehicle 604 via a holding mechanism. In this way, in a final stage of the stringing process, the aerial vehicle 604 can be configured to release the lead line to the puller 20 to be attached to the puller 20 or otherwise secured, thereby preventing the cable 606 from sliding backwards through the stringing block 606 due to gravity or tension force from the tensioner 30.

As will be appreciated, the cable 606 can be light weight such that the UAV can pull the cable 606 to a subsequent stringing block 100 a distance away on an adjacent support structure 710. Furthermore, the cable 606 can be strong enough to either pull a pulling line or a utility line into place.

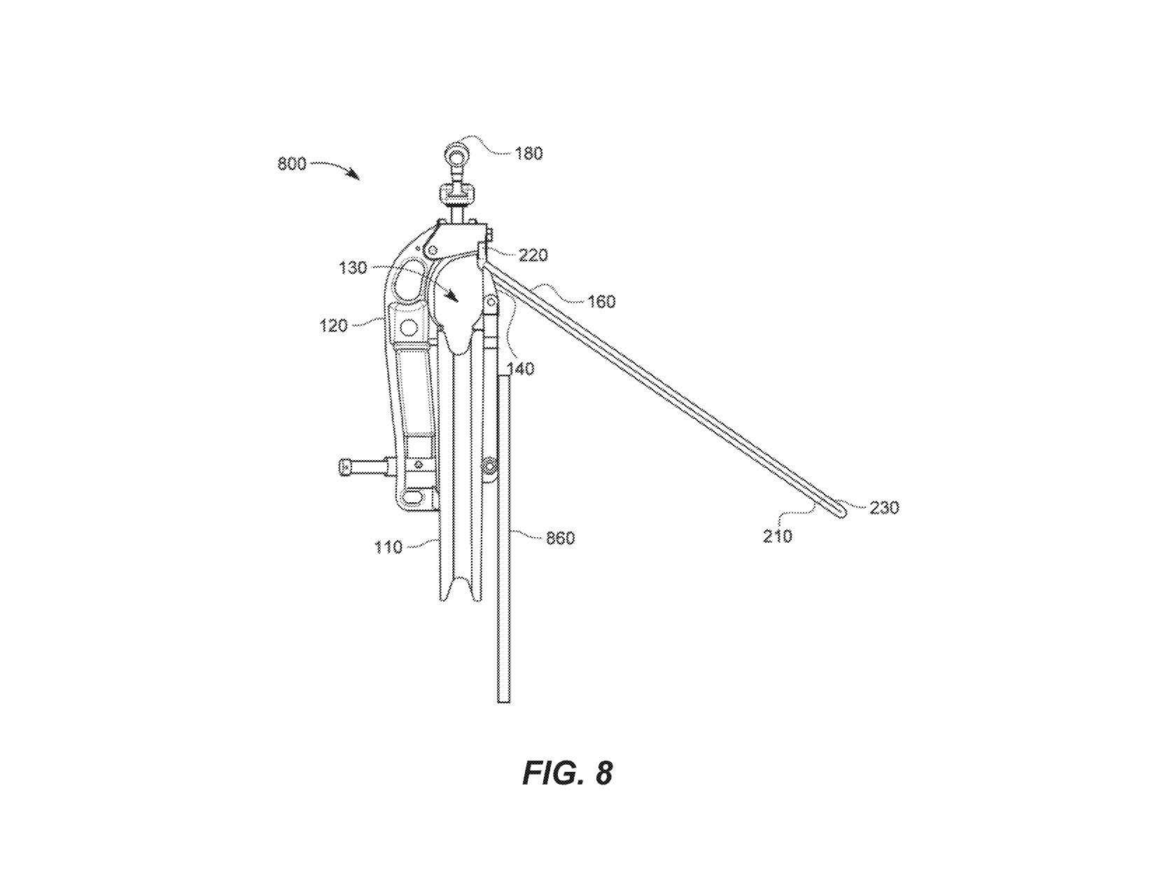

FIG. 8 illustrates a stringing block 800 including multiple arms 160, 860. In some embodiments, the arm 160 can be part of multiple arms. For example, the stringing block 800 can include the arm 160 and an arm 860. The arm 860 can include any of the features of the arm 160 as discussed herein, and can extend downward from the gate 140 as shown. The arm 860 can be configured to prevent the cable 606 from becoming tangled with the stringing block 800 such that the arm 860 can provide a barrier for the cable 606 from elements of the stringing block 800 located below the gate 140. Specifically, the arm 860 can prevent the cable 606 from becoming tangled with the axle 112. In some embodiments, the arm 860 can extend outwardly from the frame 120, such that the arm 860 can be configured to work in tandem with the arm 160 to provide a path for the cable 606. As will be appreciated, the arm 860 can extend outwardly from the frame 120 at an angle less than the angle which the arm 160 extends outwardly from the frame 120. As shown, the arm 860 can be substantially parallel to the sheave 110. In some embodiments, a length of the arm 860 can be adjustable. That is, the arm 860 can be configured to have a manually adjustable length. For example, the arm 860 can include a telescopic element, which, as is understood in the art, can allow a user to manually adjust the length of the arm 860. Additionally, the arm 860 can be configured to fold, or may include one or more hinge points, such that the length of the arm 860 may be adjusted.

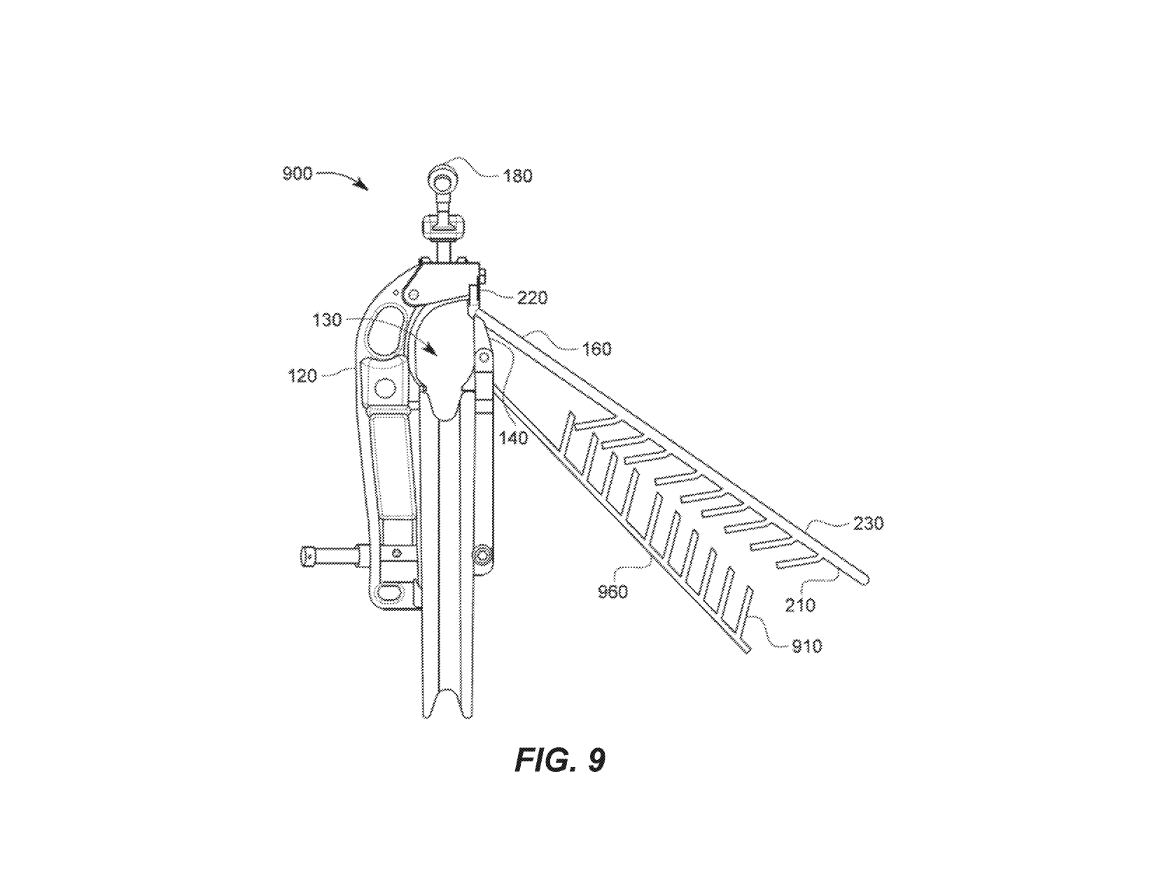

FIG. 9 illustrates a stringing block 900 including a plurality of flexible members 910. As shown in FIG. 9, the plurality of flexible members 910 can be distributed on the arm 160 and an arm 960. As can be appreciated, the arm 960 can be disposed under the bottom surface 210 of the arm 160. In some embodiments, the plurality of flexible members 910 can be disposed on the bottom surface 210 of the arm 160 and a top surface of the arm 960. In this way, the plurality of flexible members 910 can alternately overlap such that the cable can come into contact with at least one of the plurality of flexible members 910 during upwards ingress. The plurality of flexible members 910 can be configured to extend, at least partially, towards the proximal end 220. That is, the plurality of flexible members 910 can at least partially extend towards the gate 140. In this way, as can be appreciated, the plurality of flexible members 910 can be configured to allow the cable to travel from the distal end 230 to the proximal end 220, or proximally, with little resistance. Further, the plurality of flexible members 910 can be configured to prevent the cable from sliding distally or outwardly away from the stringing block 900. The plurality of flexible members 910 can thus be configured to deform at least partially in a proximal direction, so as to allow the cable to travel proximally towards the gate 140 during upwards ingress, and simultaneously be configured to be rigid in a distal direction, so as to prevent the cable from sliding distally long the arm 160 or the arm 960. For example, the plurality of flexible members 910 can be polymeric pieces that are arranged to bend toward the gate 140 when the cable is moved along the arm 160 toward the gate 140, but be configured to bend backwards if the cable is moved away from the gate 140, thereby preventing the cable from moving away from the gate 140. Thus, the plurality of flexible members 910 can include a polymeric, or specifically an elastomeric, material.

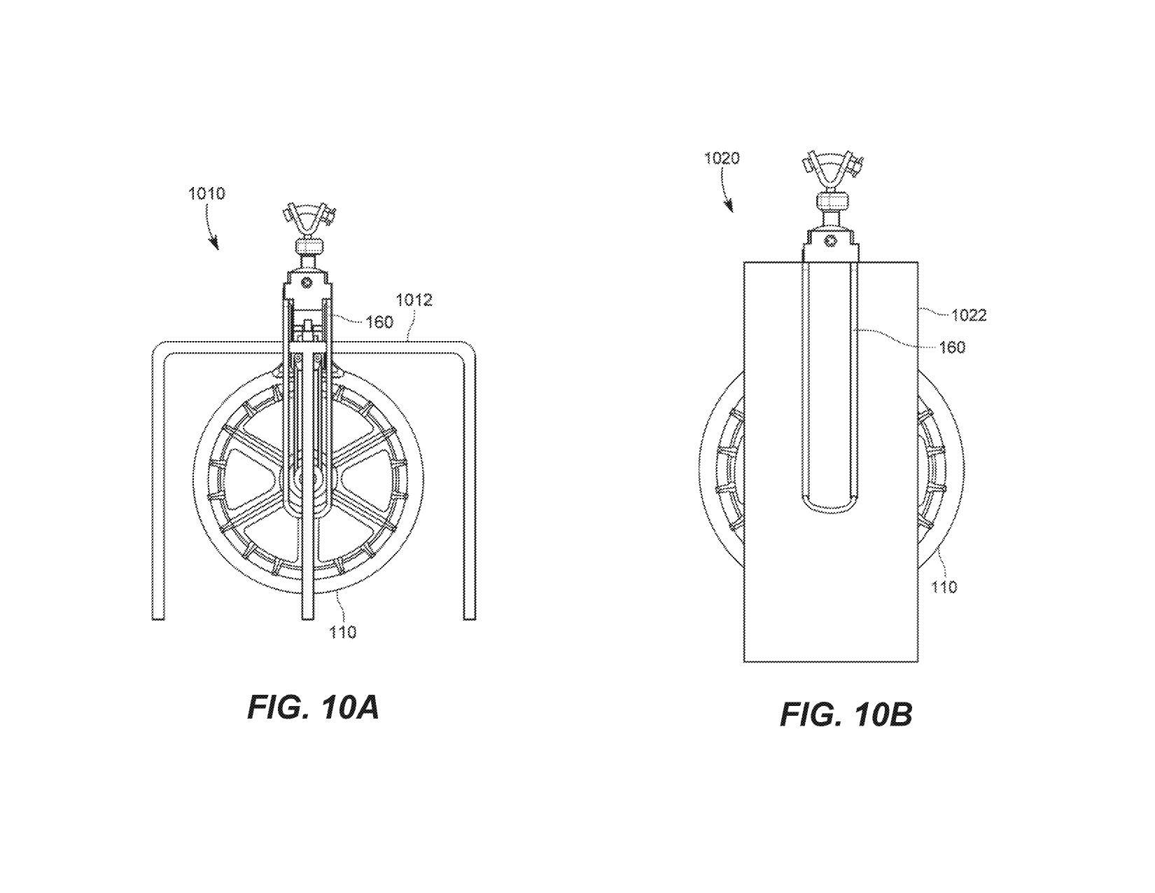

FIGS. 10A and 10B illustrate a stringing block including embodiments of a second arm, the arm 160 being a first arm. As shown in FIG. 10A, a stringing block 1010 can include an arm 1012. The arm 1012 can include any features of the arm 860 as described herein. In some embodiments, the arm 1012 can span a width greater than a width of the arm 160. Further, the arm 1012 can span a width greater than a width of the sheave 110, as shown. In this way, the arm 1012 can be configured to prevent tangling of the cable with the sheave 110, the frame 120, the axle 112, or any combination thereof. Furthermore, by being wider than the sheave 110, the arm 1012 can help to prevent rotation of the stringing block 1010 when the cable is brought into contact with the arm 1012. The arm 1012 can thus include one or more rods extending at least partially downward, or away from the arm 160, as shown. In some embodiments, the one or more rods can extend further downward than the sheave 110. Similar to as discussed herein, the one or more rods extending further downward than the sheave 110 can be to configure the arm 1012 to prevent the cable from becoming tangled with elements or features of the stringing block 1010 or any embodiments of stringing block as discussed herein.

As shown in FIG. 10B, a stringing block 1020 can include a plate 1022. The plate 1022 can include any features of the arm 860, the arm 960, or the arm 1012 as discussed herein. Further, the plate 1022 can include a single surface area spanning a width and a length as shown. In this way, the plate 1022 can be configured to prevent tangling of the cable with features of the stringing blocks as discussed herein. The plate 1022, in some embodiments, can have a width less than a width of the sheave 110 as shown. In some embodiments, the plate 1022 can have a width greater than the width of the sheave 110. Further, the plate 1022 can have a length less than a length of the arm 160. In some embodiments, the plate 1022 can have a length greater than a length of the arm 160. In some embodiments, the plate 1022 can extend downwardly past a furthest downward point of the sheave 110. By being wider than the sheave 110, the plate 1022 can help to prevent rotation of the stringing block 1020 when the cable is brought into contact with the plate 1012.

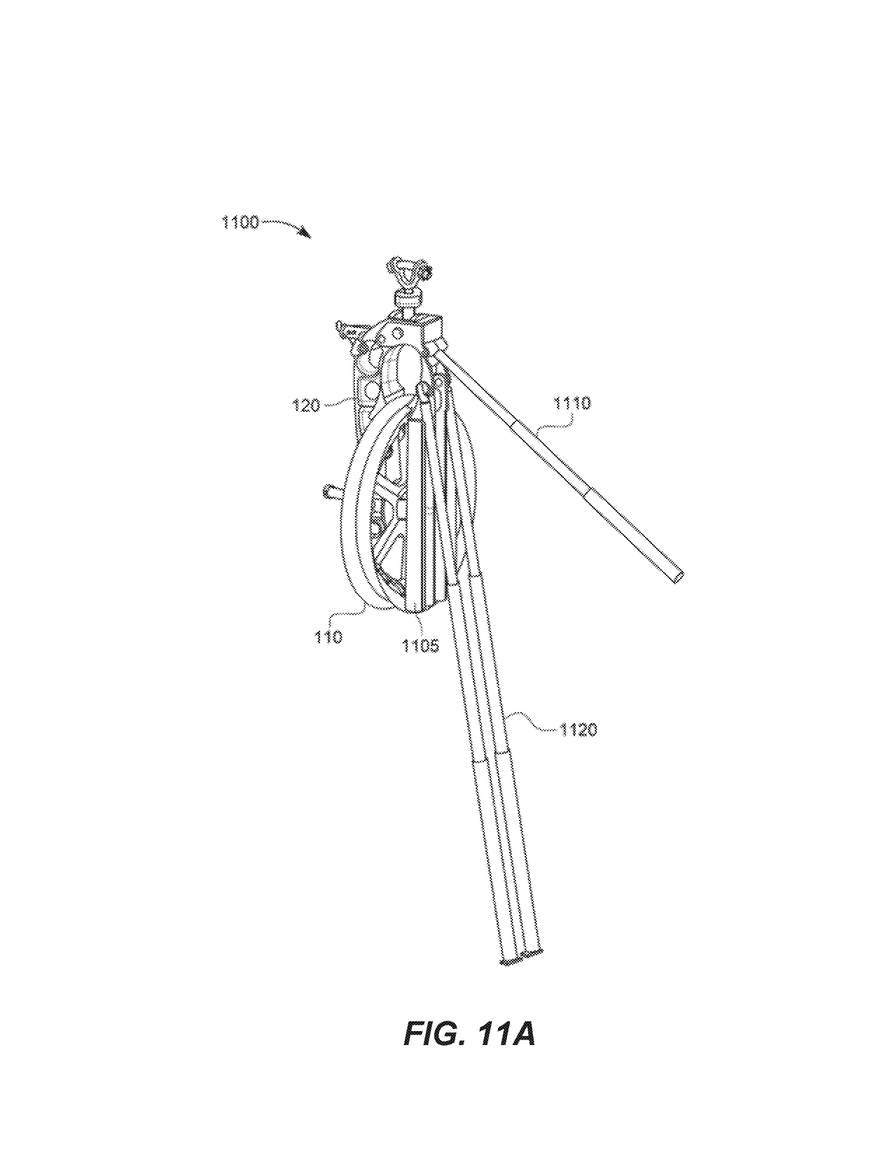

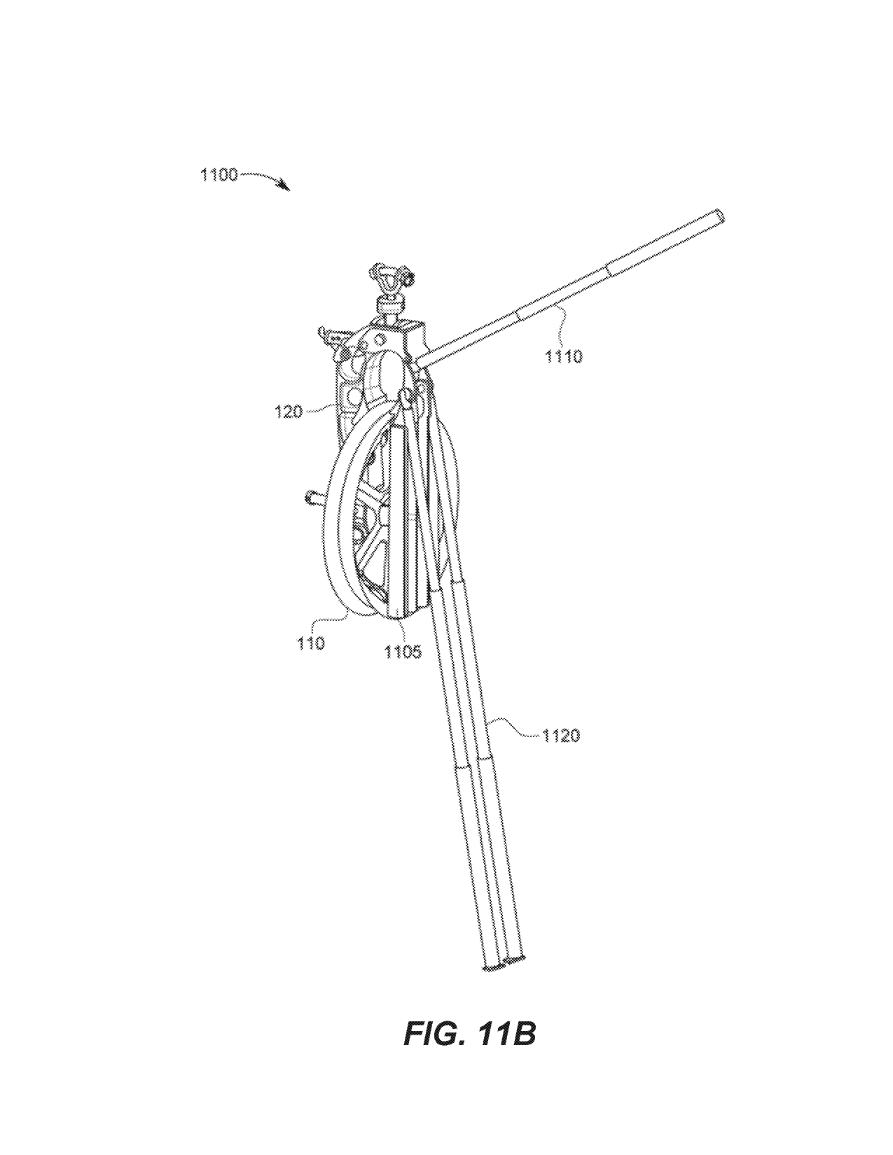

FIGS. 11A and 11B illustrate a stringing block 1100 including multiple arms. As shown in FIG. 11A, the stringing block 1100 can include a first arm 1110 and a second arm 1120. The first arm 1110 can be adjustable in length, such that a length of the first arm 1110 can be altered to configure the first arm 1110 to be extended for various stringing purposes and collapsed for temporary storage, as can be appreciated. For example, the first arm 1110 can include a telescopic element, as shown, to allow the length of the first arm 1110 to be adjustable. The first arm 1110 can extend at an oblique angle to the sheave 110, and can be further configured to have the oblique angle of the first arm 1110 be adjustable. In this way, various oblique angles of extensions of the first arm 1110 can be achieved. For example, the first arm 1110 can extend downwardly at the oblique angle as shown in FIG. 11A. The oblique angle can be any angle between 0 degrees and 180 degrees with reference to the sheave 110 or the stringing block 1100. In some embodiments, the oblique angle is selected such that the first arm 1110 extends downwardly, as shown in FIG. 11A.

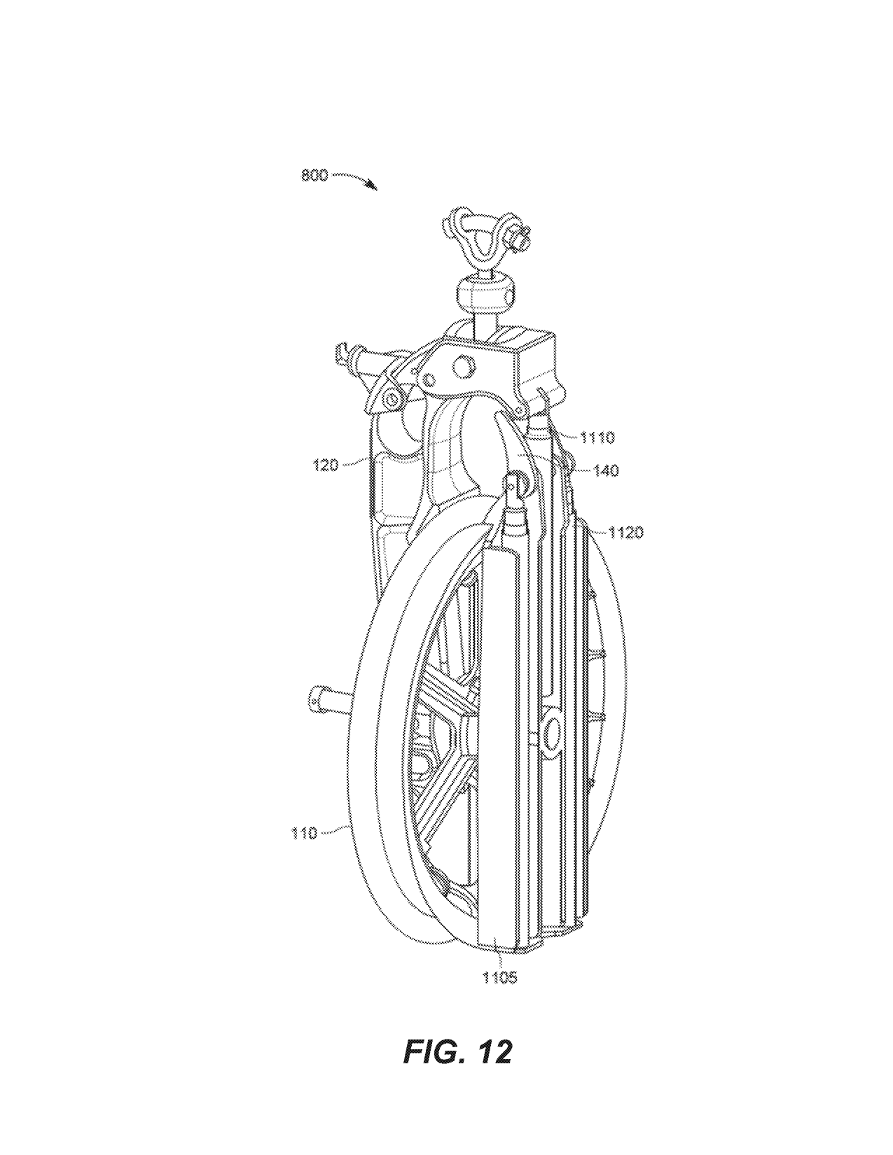

Further, the second arm 1120 can be adjustable in length, such that a length of the second arm 1120 can be altered to configure the second arm 1120 to be extended for various stringing purposes and collapsed for temporary storage, as shown in FIG. 12. For example, the second arm 1120 can include a telescopic element, as shown, to allow the length of the second arm 1120 to be adjustable. The second arm 1120 can include a telescopic element, as shown, to allow the length of the second arm 1120 to be adjustable. In some embodiments, the second arm 1120 can be part of multiple second arms, extending in a substantially similar direction, as shown in FIG. 11A. The multiple second arms can be connected, or tied, together, so as to prevent the cable from becoming tangled or intertwined between second arms 1120 of the multiple second arms 1120. In some embodiments, as shown in FIG. 11A and 11B, the multiple second arms can be connected at a distal end of the multiple second arms 1120. The second arm 1120 can extend at an angle such that the second arm 1120 is positioned below the first arm 1110, such that a window configured to receive the cable exists between the first arm 1110 and the second arm 1120. That is, the window can be defined as a region between the first arm 1110 and the second arm 1120, in that, as can be appreciated, the size of the window can be dependent on at least the oblique angle selected for the first arm 1110 and the second arm 1120. The stringing block 1100 can further include a storage element 1105 configured to temporarily store the multiple arms, as will be discussed in greater detail herein. The storage element 1105 can further function similar to the plate 1022 or the arm 1012 including multiple arms. For example, the storage element 1105 can be wider than the sheave 110 and help to prevent rotation of the stringing block 1100 when the cable is brought into contact with the plate storage element 1105.

As shown in FIG. 11B, the first arm 1110 can extend upwardly at an oblique angle. In this way, the angle of the first arm 1110 can be adjusted such that the first arm 1110 extends upwardly so as to increase a size of the window. A greater size of the window can ease the upward ingress, in that, as can be appreciated, a greater window size can allow for easier handling of the aerial vehicle and more room for error with movement of the cable during upwards ingress.

FIG. 12 illustrates the stringing block 1100 in a closed configuration. As can be appreciated, during installation of the stringing block 1100, the closed configuration can be more compact and thus easier to install than embodiments of stringing blocks as discussed herein, specifically with one or more arms extending outwardly from the stringing block. That is, the closed configuration of the stringing block 1100 can include the first arm 1110 and one or more second arms 1120 in collapsed configurations, such that lengths of the first arm 1110 and the one or more second arms 1120 can be at least temporarily stored in the storage element 1105, as shown. In this way, the stringing block 1100 can be easily transported and adjustable, in that the stringing block 1100 can be used for stringing utility lines on a first structure then be easily removed, collapsed, transported, and installed on a second structure. Additionally, the adjustable elements, including lengths and angles of extension, of the first arm 1110 and the one or more second arms 1120 can include a first configuration on the first structure and a second configuration on the second structure. In this way, the stringing block 1100 can be adaptable to various structures, various needs for stringing utility lines, and can include various window sizes to be configured to needs of corresponding structures.

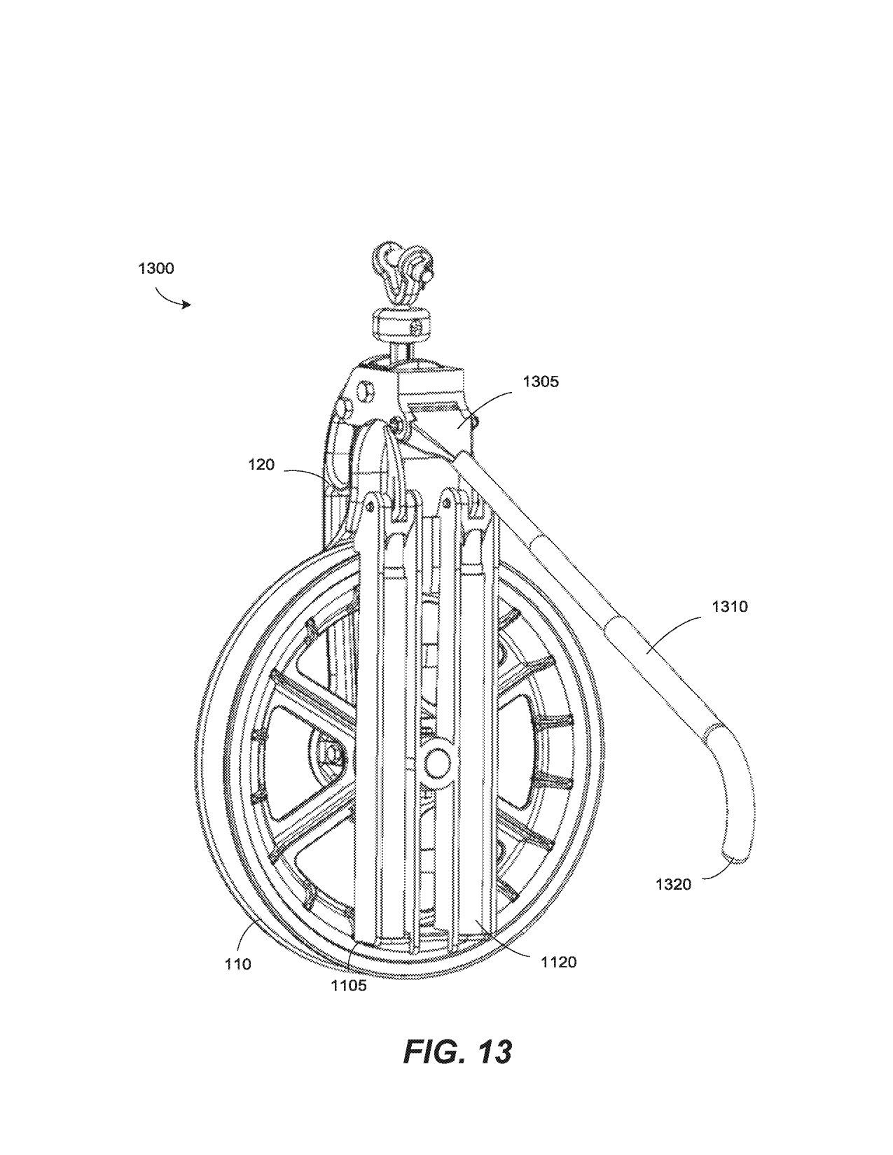

FIG. 13 illustrates a stringing block 1300 including an arm 1310 with a hook 1320 disposed at a distal end of the arm 1310. As can be appreciated, the stringing block 1300 can include any examples of stringing blocks discussed herein. As shown, the stringing block 1300 can include the frame 120, the sheave 110, the storage element 1105, and the second arm 1120. Additionally, the stringing block 1300 can include a coupling 1305 hingedly connecting the arm 1310 to the frame 120. As discussed for the arm 160, the arm 860, the arm 960, and the first arm 1110, the arm 1310 can extend from a proximal end to a distal end. The arm 1310 can be attached to the coupling 1305 at the proximal end, with the hook 1320 disposed at the distal end. The hook 1320 can include any examples of the hook 410 discussed herein.

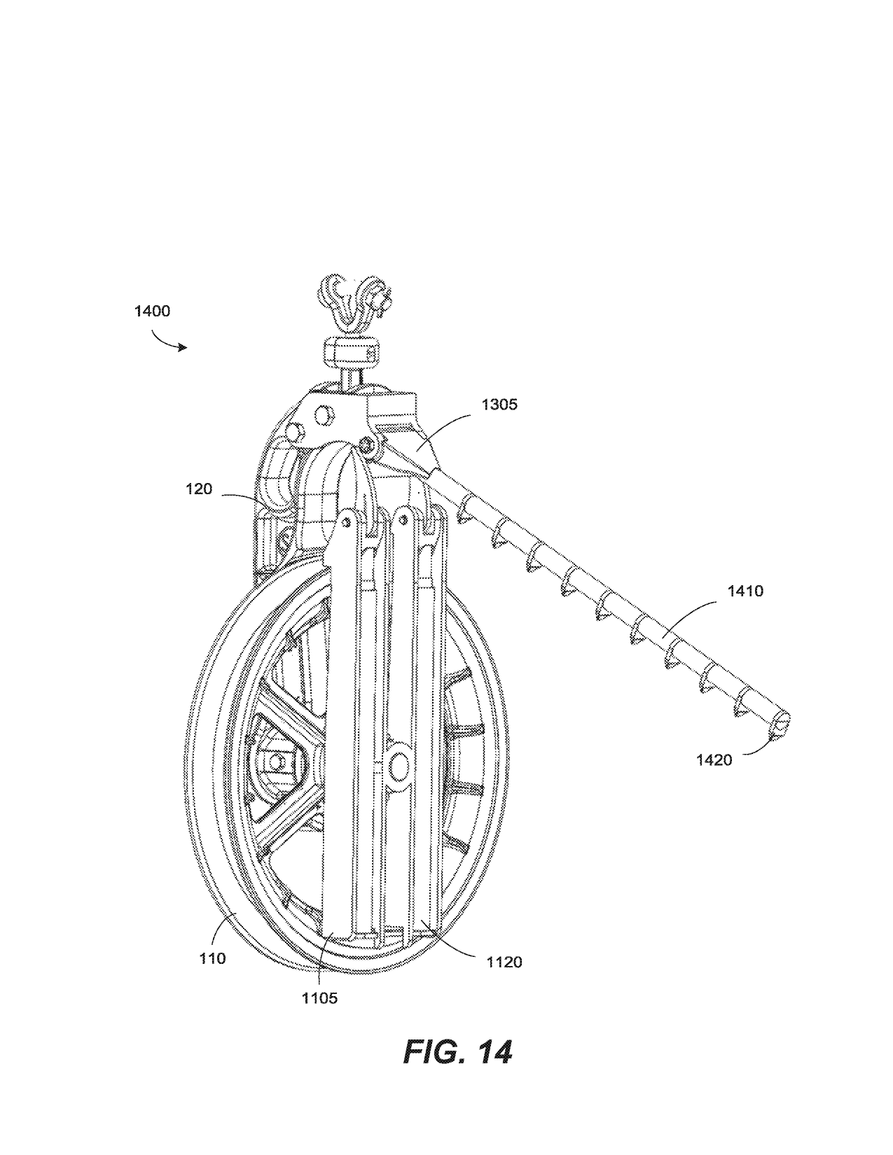

FIG. 14 illustrates a stringing block 1300 including an arm 1410 with a plurality of ridges 1420. The stringing block 1400 can include any examples of stringing blocks discussed herein. For example, the stringing block 1400 can include any examples of the stringing block 1300, in that the stringing block 1400 can include the frame 120, the sheave 110, the storage element 1105, and the second arm 1120. The stringing block 1400 can further include the coupling 1305 hingedly attaching the arm 1410 at a proximal end to the frame 120.

The plurality of ridges 1420 can include any examples of the one or more ridges 510 discussed herein. That is, the plurality of ridges 1420 can be disposed along a length of the arm 1410 from the proximal end to a distal end, and can protrude downwardly to interact with a cable and prevent the cable from sliding distally along the length of the arm 1410.

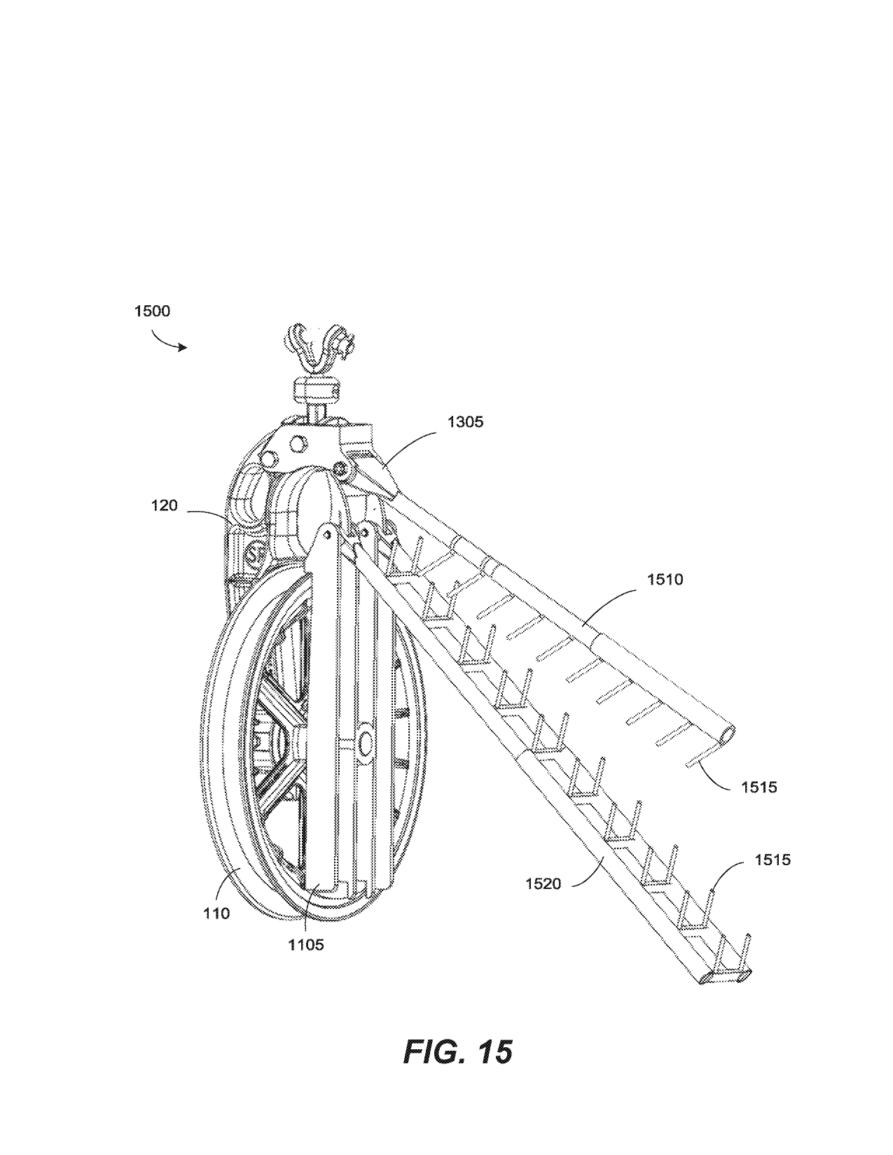

FIG. 15 illustrates a stringing block 1500 including a first arm 1510, a second arm 1520, and a plurality of flexible members 1515 respectively disposed thereupon. The stringing block 1500 can include any examples of stringing blocks discussed herein. For example, the stringing block can include any examples of the stringing block 1300 and the stringing block 1400, in that the stringing block 1500 can include the frame 120, the sheave 110, the storage element 1105, and the coupling 1305. As before, the coupling 1305 can hingedly connect, at a proximal end, the first arm 1510 to the frame 120. As shown, the first arm 1510 and the second arm 1520 can extend outwardly from the frame 120 of the stringing block 1500. In some examples, the first arm 1510 and the second arm 1520 can extend downwardly from respective proximal ends, as shown.

The plurality of flexible members 1515 can include any examples of the plurality of flexible members 910 discussed herein. That is, the plurality of flexible members 1515 can be disposed along lengths of the first arm 1510 and the second arm 1520, respectively, extending from a proximal end to a distal end. In some examples, the plurality of flexible members 1515 can include a first set of flexible members disposed on the first arm 1510 and a second set of flexible members disposed on the second arm 1520. As shown, the first set of flexible members can extend substantially downwardly from the first arm 1510 and the second set of flexible members can extend substantially upwardly from the second arm 1520. In this way, the first and second sets of flexible members can prevent a cable disposed between the first arm 1510 and the second arm 1520 from translating distally with respect to the first arm 1510 and the second arm 1520.

Further, the second arm 1520 can include two rods extending distally from the frame 120 with crossbeams disposed along the length of the second arm 1520. As shown, the second set of flexible members can be disposed on the crossbeams. In other example, the second set of flexible members can be disposed on the rods of the second arm 1520.

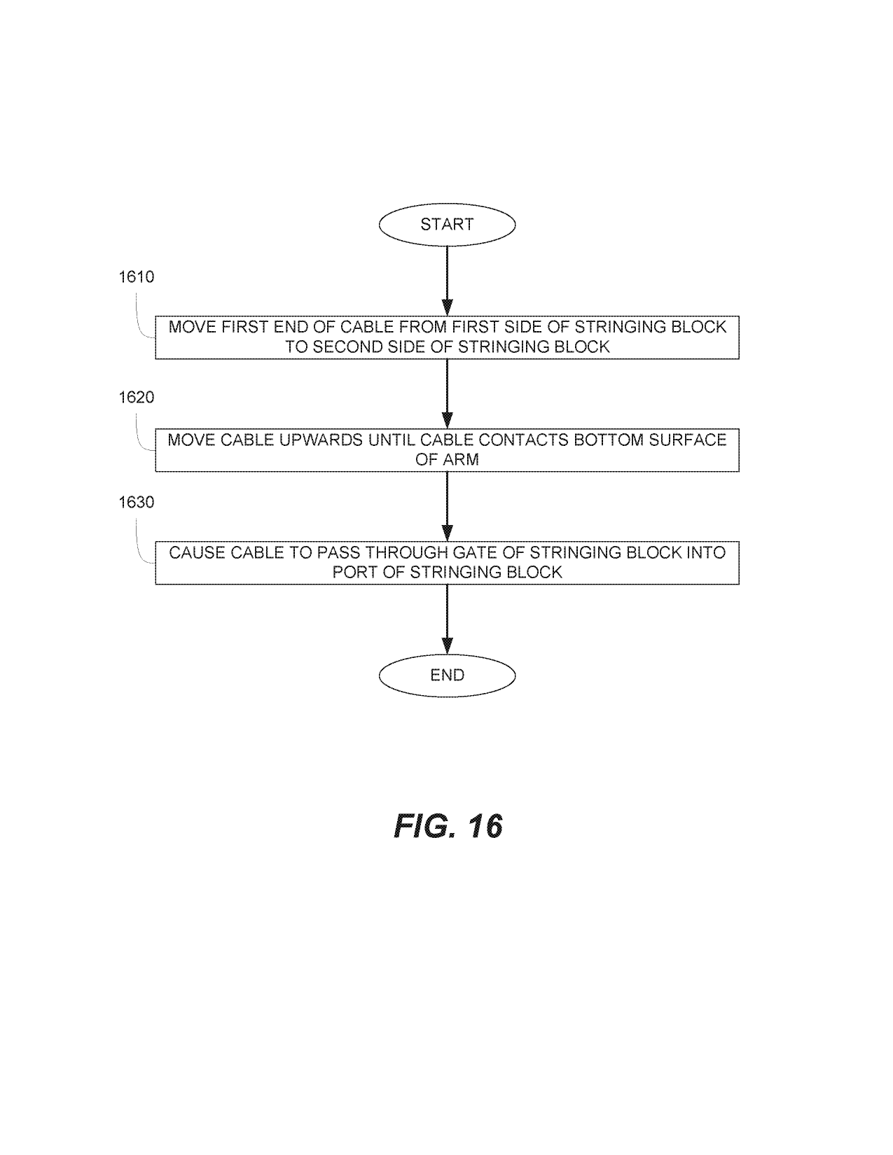

FIG. 16 illustrates a block diagram of an example method 1600 in accordance with the methods as described herein. The method 1600 can include moving 1610 a first end of a cable from a first side of a stringing block to a second side of the stringing block. The first end of the cable can be moved from the first side of the stringing block to the second side of the stringing block such that the cable can extend past the stringing block. The method 1600 can further include moving 1620 a cable upwards until a cable contacts a bottom surface of an arm of the stringing block. As described herein, the arm can be extending outwardly and downwardly from the stringing block at an oblique angle. The method 1600 can further include causing 1630 the cable to pass through the gate of the stringing block into a port of the stringing block. For example, as the aerial vehicle moves upwardly, the force of the cable being pulled upwardly and against the gate can cause the gate to open and the cable to be passed into the port of the stringing block.

The method 1600 just described is offered for explanatory purposes and should not be construed as limited to the particular steps and order of steps just described. That is, the method 1600 just described can include other intervening steps not described or the method 1600 can be completed in an order other than described herein. Accordingly, the method 1600 should be understood in the context of the entire disclosure presented herein.

The disclosed technology can be further understood according to the following clauses:

Clause 1: A method of stringing a utility line using an aerial vehicle, the method comprising: moving a first end of a cable from a first side of a stringing block to a second side of the stringing block using the aerial vehicle such that the cable extends past the stringing block; moving the cable upwards until the cable contacts a bottom surface of an arm extending outwardly from the stringing block; and causing the cable to pass through a gate of the stringing block and into a port of the stringing block by moving the cable upwards along the arm until the cable passes through the gate.

Clause 2: The method of Clause 1, wherein the first end of the cable is attached to an aerial vehicle.

Clause 3: The method of Clause 2, wherein moving the first end of the cable from the first side of the stringing block to the second side of the stringing block comprises navigating the aerial vehicle from the first side of the stringing block to the second side of the stringing block.

Clause 4: The method of Clause 2, wherein moving the cable upwards comprises navigating the aerial vehicle upwards.

Clause 5: The method of Clause 2, wherein the aerial vehicle is an unmanned aerial vehicle (UAV).

Clause 6: The method of Clause 1, wherein the cable comprises a pilot line, and wherein a first end of the pilot line is attached to an aerial vehicle and a second end of the pilot line is attached to one or more trailing cables.

Clause 7: The method of Clause 6, wherein the pilot line contacts the bottom surface of the arm of the stringing block.

Clause 8: The method of Clause 6, wherein causing the cable to pass through a gate of the stringing block and into the port of the stringing block comprises: receiving the pilot line into the port of the stringing block via the gate; and receiving the one or more trailing cables into the port by advancing the second end of the pilot line through the port.

Clause 9: The method of Clause 1, wherein causing the cable to pass through the gate of the stringing block and into the port of the stringing block comprises: moving the cable to the gate; applying a force on the gate with the cable; and passing the cable through the gate when the gate opens due to the force.

Clause 10: The method of Clause 9, wherein the gate is configured to allow one-way entry into the port.

Clause 11: The method of Clause 1, wherein moving the first end of the cable from the first side of the stringing block to the second side of the stringing block further comprises moving the cable underneath an arm of the stringing block.

Clause 12: The method of Clause 1, further comprising tensioning the cable.

Clause 13: The method of Clause 1, wherein the arm further comprises a hook configured to prevent the cable from sliding off a distal end of the arm.

Clause 14: The method of Clause 1, wherein the arm further comprises one or more ridges along a length of the arm, wherein the one or more ridges are configured to prevent the cable from sliding distally along the arm.

Clause 15: A stringing block comprising: a sheave configured to receive a cable; and a frame comprising: a port configured to receive the cable; and a gate configured to permit entry of the cable into the port; and an arm attached to the frame and extending downwardly from the frame at an oblique angle.

Clause 16: The stringing block of Clause 15, wherein the frame further comprises a top connection, located at a top end, configured to be attached to a support structure.

Clause 17: The stringing block of Clause 15, wherein the arm further comprises a hook located at a distal end of the arm, wherein the hook is configured to prevent the cable from sliding off the arm at the distal end.

Clause 18: The stringing block of Clause 15, wherein the arm further comprises one or more ridges along a length of the arm, wherein the one or more ridges are configured to prevent the cable from sliding distally along the arm.

Clause 19: The stringing block of Clause 15, wherein the gate is configured to allow one-way entry into the port.

Clause 20: The stringing block of claim 15, wherein the stringing block further comprises a plurality of sheaves.

Clause 21: The stringing block of clause 15, wherein the arm is a first arm and the stringing block further comprises a second arm extending downward from the frame, wherein the cable is guided to the gate between the first arm and the second arm.

Clause 22: The stringing block of clause 21, wherein the second arm comprises a plurality of second arms.

Clause 23: The stringing block of clause 21, wherein the second arm comprises a plate.

Clause 24: The stringing block of clause 15, wherein the arm is configured to be adjustable between a plurality of different angles with respect to the frame.

Clause 25: The stringing block of claim 15, wherein the arm is configured to extend between a first length and a second length.

While the present disclosure has been described in connection with a plurality of exemplary aspects, as illustrated in the various figures and discussed above, it is understood that other similar aspects can be used, or modifications and additions can be made to the described subject matter for performing the same function of the present disclosure without deviating therefrom. In this disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims.

What is claimed is:

1. A method of stringing a utility line using an aerial vehicle, the method comprising:
moving a first end of a cable from a first side of a stringing block to a second side of the stringing block using the aerial vehicle such that the cable extends past the stringing block;
moving the cable upwards until the cable contacts a bottom surface of an arm extending outwardly from the stringing block; and
causing the cable to pass through a gate of the stringing block and into a port of the stringing block by moving the cable upwards along the arm until the cable passes through the gate.

2. The method of claim 1, wherein the first end of the cable is attached to an aerial vehicle.

3. The method of claim 2, wherein moving the first end of the cable from the first side of the stringing block to the second side of the stringing block comprises navigating the aerial vehicle from the first side of the stringing block to the second side of the stringing block.

4. The method of claim 2, wherein moving the cable upwards comprises navigating the aerial vehicle upwards.

5. The method of claim 2, wherein the aerial vehicle is an unmanned aerial vehicle (UAV).

6. The method of claim 1, wherein the cable comprises a pilot line, and wherein a first end of the pilot line is attached to an aerial vehicle and a second end of the pilot line is attached to one or more trailing cables.

7. The method of claim 6, wherein causing the cable to pass through a gate of the stringing block and into the port of the stringing block comprises:
receiving the pilot line into the port of the stringing block via the gate; and
receiving the one or more trailing cables into the port by advancing the second end of the pilot line through the port.

8. The method of claim 1, wherein causing the cable to pass through the gate of the stringing block and into the port of the stringing block comprises:
moving the cable to the gate;
applying a force on the gate with the cable; and
passing the cable through the gate when the gate opens due to the force.

9. The method of claim 1, wherein moving the first end of the cable from the first side of the stringing block to the second side of the stringing block further comprises moving the cable underneath an arm of the stringing block.

10. The method of claim 1, wherein the arm further comprises a hook configured to prevent the cable from sliding off a distal end of the arm.

11. The method of claim 1, wherein the arm further comprises one or more ridges along a length of the arm, wherein the one or more ridges are configured to prevent the cable from sliding distally along the arm.

12. A stringing block comprising:
a sheave configured to receive a cable;
a frame comprising:
a port configured to receive the cable; and
a gate configured to permit entry of the cable into the port; and
an arm attached to the frame and extending downwardly from the frame at an oblique angle.

13. The stringing block of claim 12, wherein the frame further comprises a top connection, located at a top end, configured to be attached to a support structure.

14. The stringing block of claim 12, wherein the arm further comprises a hook located at a distal end of the arm, wherein the hook is configured to prevent the cable from sliding off the arm at the distal end.

15. The stringing block of claim 12, wherein the arm further comprises one or more ridges along a length of the arm, wherein the one or more ridges are configured to prevent the cable from sliding distally along the arm.

16. The stringing block of claim 12, wherein the stringing block further comprises a plurality of sheaves.

17. The stringing block of claim 12, wherein the arm is a first arm and the stringing block further comprises a second arm extending downward from the frame, wherein the cable is guided to the gate between the first arm and the second arm.

18. The stringing block of claim 17, wherein the second arm comprises a plurality of second arms.

19. The stringing block of claim 12, wherein the arm is configured to be adjustable between a plurality of different angles with respect to the frame.

20. The stringing block of claim 12, wherein the arm is configured to extend between a first length and a second length.
